(19) United States
(12) Patent Application Publication
(10) Pub. No.: US 2012/0066638 A1
(43) Pub. Date: Mar. 15, 2012

(54) MULTI-DIMENSIONAL AUTO-SCROLLING

(75) Inventor: Rahul Ohri, Sammamish, WA (US)

(73) Assignee: Microsoft Corporation, Redmond, WA (US)

(21) Appl. No.: 12/878,924

(22) Filed: Sep. 9, 2010

(51) Int. Cl. G06F 3/048

(52) U.S. Cl. 715/784

(57) ABSTRACT

A content presentation system implemented as a web browser, electronic book reader, etc., can initiate multi-dimensional auto-scroll movement in response to a single instance of user input (e.g., a gesture on a touchscreen). Once initiated, such a system can move visual information in more than one dimension, without further user input, to present content to a user. For example, a content presentation system can move visual information from right to left across a display area and, when the right end of the text has been reached, shift the visual information vertically, return to a starting horizontal alignment, and begin the right to left movement again, thereby performing movement that mimics left-to-right, top-to-bottom movement of human eyes, as would occur when reading text in many languages, such as English. A user can engage, accelerate, decelerate, and disengage multi-dimensional auto-scrolling, and set limits on scrolling ranges to focus on important content.

### BACKGROUND

The proliferation of content available for consumption on the World Wide Web and the increasing variety and ubiquity of devices that can be used to access such content has led to an increased demand for applications such as web browsers and document readers that provide a high-quality user experience when displaying content. A common drawback of such applications is their heavy reliance on user interaction. Such applications typically rely on users to tell the application, through repeated user input, what the application needs to do to present the content in a readable form. For example, when a user accesses a web page with a web browser in order to read an article on the web page, the web browser requires input from a user (e.g., in the form of mouse clicks that cause a web page to scroll in one direction or another) every time the user wishes to move unread text on the web page into the display area.

Furthermore, while mobile devices are making rapid gains in popularity compared with traditional workstations, a relative lack of screen area in mobile devices means that content presented on web pages almost never fits within the display area of mobile devices. Although web pages can be designed for smaller screens, current designs shy away from text-only or mobile-optimized views and instead try to present users with an experience that mimics a traditional desktop experience on their mobile devices. While some mobile devices are capable of displaying pages in different ways, such as zooming out to presenting a whole-page or “holistic” view, such views often cause the content on the page, especially text, to be too small to be comprehensible. Zooming in can expand content on a web page to a more useful scale, but the page will often substantially exceed the available screen area.

Although there have been a variety of advances in presenting content to users, there remains room for improvement.

### SUMMARY

Technologies described herein relate to presenting content with multi-dimensional auto-scrolling, which can also be referred to as progressive auto-scrolling or eye drive scrolling. In one common content presentation task, a computing device presents content to a user on a screen that is too small to display all of the content at once, at a scale that is comprehensible to the user. Multi-dimensional auto-scroll movement can be used to present content that moves in a way that mimics the way human eyes move over content on a page, allowing the user to focus on the content while requiring less interaction with the device.

For example, a web browser, electronic book reader, etc., can initiate multi-dimensional auto-scroll movement in response to a single instance of user input (e.g., a gesture on a touchscreen). Once initiated, such a system can move visual information in more than one dimension, without further user input. For example, text can be moved from right to left across a display area, shifted vertically, and returned to a starting horizontal alignment to begin the right-to-left movement again, thereby performing movement that mimics left-to-right, top-to-bottom movement of human eyes, as would occur when reading text in many languages, such as English. Multi-dimensional auto-scroll movement also can be performed in other ways, such as by moving visual information from left to right across a display area to mimic right-to-left movement of human eyes, as would occur when reading text in languages such as Arabic. Such movement can be referred to as eye-drive movement. A user can engage, accelerate, decelerate, and disengage multi-dimensional auto-scrolling, and perform other related tasks, such as setting limits on scrolling ranges to focus on content that is important to the user.

As described herein, a variety of other features and advantages can be incorporated into the technologies as desired.

The foregoing and other features and advantages will become more apparent from the following detailed description of disclosed embodiments, which proceeds with reference to the accompanying drawings.

### BRIEF DESCRIPTION OF THE FIGURES

FIG. 1 is a block diagram of an exemplary system implementing the multi-dimensional auto-scrolling technologies described herein.

FIG. 2 is a flowchart of an exemplary method of implementing the multi-dimensional auto-scrolling technologies described herein.

FIG. 3 is a conceptual diagram of an exemplary two-dimensional auto-scrolling feature.

FIG. 4 is a block diagram of another exemplary system implementing the multi-dimensional auto-scrolling technologies described herein.

FIG. 5 is a diagram of several exemplary multi-dimensional gestures.

FIG. 6 is a flowchart of another exemplary method of implementing the multi-dimensional auto-scrolling technologies described herein.

FIG. 7 is a conceptual diagram of another exemplary two-dimensional auto-scrolling feature.

FIG. 8 is a flowchart of another exemplary method of implementing the multi-dimensional auto-scrolling technologies described herein.

FIG. 9 is a conceptual diagram of another exemplary two-dimensional auto-scrolling feature.

FIG. 10 is a conceptual diagram of another exemplary two-dimensional auto-scrolling feature.

FIG. 11 is a conceptual diagram of another exemplary two-dimensional auto-scrolling feature.

FIG. 12 is a conceptual diagram of another exemplary two-dimensional auto-scrolling feature.

FIG. 13 is a conceptual diagram of another exemplary two-dimensional auto-scrolling feature.

FIG. 14 is a flowchart of another exemplary method of implementing the multi-dimensional auto-scrolling technologies described herein.

FIG. 15 is a diagram of an exemplary user interface accepting additional information for control of one or more multi-dimensional auto-scrolling features.

FIG. 16 is a block diagram of an exemplary computing environment suitable for implementing any of the technologies described herein.

FIG. 17 is a block diagram of an exemplary cloud computing arrangement suitable for implementing any of the technologies described herein.

FIG. 18 is a block diagram of an exemplary mobile device suitable for implementing any of the technologies described herein.

### DETAILED DESCRIPTION

### Example 1

### Exemplary Overview

Technologies described herein relate to presenting content with multi-dimensional auto-scrolling, which can also be referred to as progressive auto-scrolling or eye drive scrolling. In one common content presentation task, a device presents visual information to a user on a screen that is too small to display all of the visual information at once, at a scale that is comprehensible to the user. For example, a user may wish to view a list of books on a book retailer's website or read a news article on a news provider's website. A user may have to scroll a viewed page in more than one dimension (e.g., horizontally and vertically) in order to view all the visual information on a page. This can lead to a lot of interaction between the user and the device, which takes the user's focus away from content.

Typically, a user views a page in a sequential way, according to a predictable eye scan pattern. Depending on the user's preferred language, the user's eye scan pattern may involve scanning from left to right and from top to bottom, or from right to left and from top to bottom, although other patterns also are possible. Multi-dimensional auto-scroll movement can mimic the way human eyes move over content on a page, allowing the user to focus on the content while requiring less interaction with the device.

For example, a web browser, electronic book reader, etc., can initiate multi-dimensional auto-scroll movement in response to a single instance of user input (e.g., a gesture on a touchscreen). Once initiated, such a system can move visual information in more than one dimension, without further user input. For example, text can be moved from right to left across a display area, shifted vertically, and returned to a starting horizontal alignment to begin the right-to-left movement again, thereby performing movement that mimics left-to-right, top-to-bottom movement of human eyes, as would occur when reading text in many languages, such as English. Multi-dimensional auto-scroll movement also can be performed in other ways, such as by moving visual information from left to right across a display area to mimic right-to-left movement of human eyes, as would occur when reading text in languages such as Arabic. Such movement can be referred to as eye-drive movement. A user can engage, accelerate, decelerate, and disengage multi-dimensional auto-scrolling, and perform other related tasks, such as setting limits on scrolling ranges to focus on content that is important to the user.

### Example 2

### Exemplary Content

The technologies described herein can be used to present content to a user. Any of the techniques and tools described herein can assist in presenting content in various formats, such as web pages, documents, and the like. Content can include visual information such as text, images, embedded video clips, animations, graphics, interactive visual content (e.g., buttons or other controls, clickable icons and hyperlinks, etc.), and the like. Content also can include non-visual information such as audio. Described techniques and tools that use scrolling movement to present visual information to users are beneficial, for example, when presenting visual information that cannot be displayed in a readable form all at once in a display area. This situation is commonly encountered when users employ devices with small display areas (e.g., smartphones) to view content (e.g., web pages) that is designed to be displayed on devices with a larger display area (e.g., desktop or laptop computers).

### Example 3

### Exemplary System Employing a Combination of the Technologies

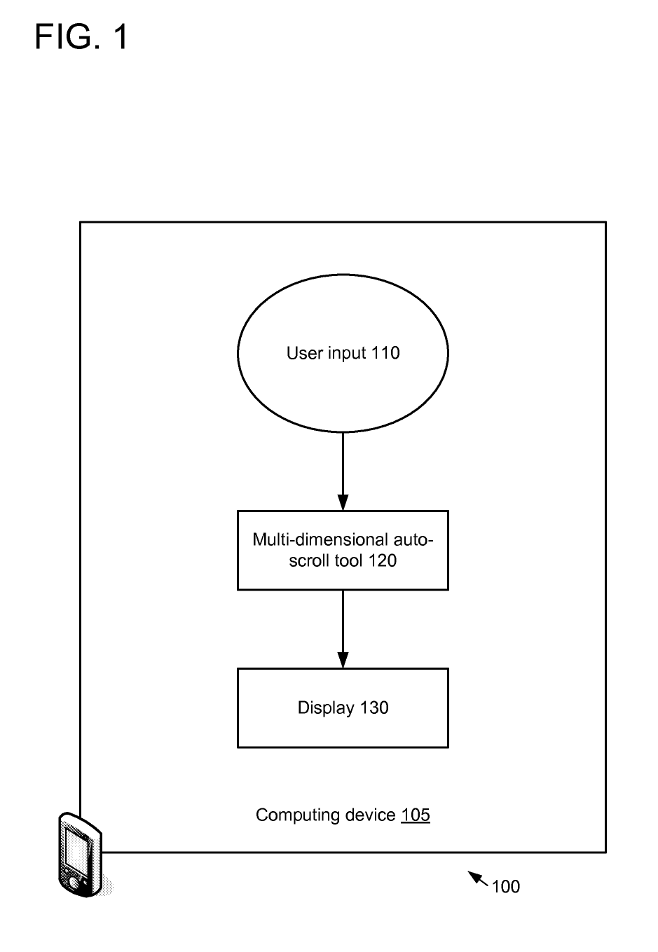

FIG. 1 is a block diagram of an exemplary system 100 implementing multi-dimensional auto-scrolling technologies described herein. In the example, one or more computing devices 105 implement a multi-dimensional auto-scroll tool 120 that accepts user input 110 to initiate a multi-dimensional auto-scroll movement in content presented to the user on display 130.

In practice, the systems shown herein such as system 100 can be more complicated, with additional functionality, more complex relationships between system components, and the like. The technologies described herein can be generic to the specifics of operating systems or hardware and can be applied in any variety of environments to take advantage of the described features.

### Example 4

### Exemplary Method of Applying a Combination of the Technologies

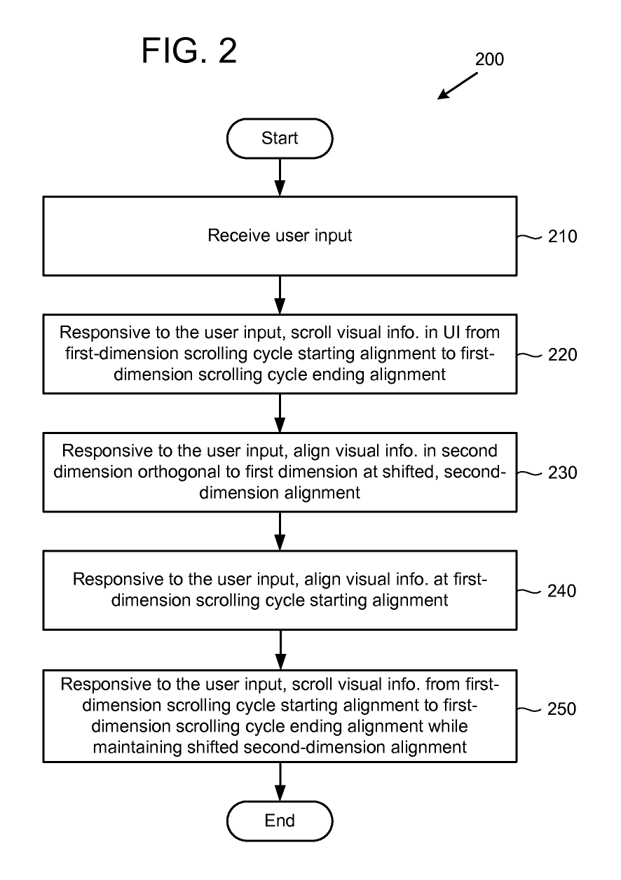

FIG. 2 is a flowchart of an exemplary method 200 of implementing the multi-dimensional auto-scrolling technologies described herein and can be implemented, for example, in a system such as that shown in FIG. 1. The technologies described herein can be generic to the specifics of operating systems or hardware and can be applied in any variety of environments to take advantage of the described features.

At 210, the system receives user input, and at 220, in response to the user input the system scrolls visual information (e.g., a web page, a document, etc.) in a user interface from a first-dimension (e.g., horizontal) scrolling cycle starting alignment to a first-dimension scrolling cycle ending alignment. As described herein, user input can be touch-based input, such as gestures on a touchscreen. User input also can be other input, such as keypad input, mouse input, trackball input, voice input, and the like. As described herein, the first-dimension scrolling cycle starting alignment can be a horizontal scrolling cycle starting alignment of a viewport in the user interface. In the example, the first-dimension scrolling cycle starting alignment refers to the alignment of a viewport where a full cycle of scrolling in the first dimension (e.g., from a left edge of content to a right edge of content) begins, although auto-scrolling movement can be initiated at other positions (e.g., a position between a scrolling cycle starting alignment and a scrolling cycle ending alignment).

At 230, in response to the user input the visual information is aligned in the user interface in a second dimension (e.g., a vertical dimension) orthogonal to the first dimension at a shifted, second-dimension alignment, and at 240, in response to the user input the visual information is aligned in the user interface at the first-dimension scrolling cycle starting alignment. The movement of the visual information to the first-dimension scrolling cycle starting alignment and the shifted, second-dimension alignment can occur at the same time or at different times, and such movement can be presented in different ways.

At 250, in response to the user input the visual information is scrolled from the first-dimension scrolling cycle starting alignment to the first-dimension scrolling cycle ending alignment while maintaining the shifted, second-dimension alignment. Maintaining the shifted, second dimension alignment during such a scrolling movement can be useful, for example, in allowing a user to follow a line of text during multi-dimensional auto-scrolling. Processing steps such as the steps described above or in other examples herein can be repeated, for example, to continue auto-scrolling to the end of a document, web page, or the like.

The method 200 and any of the methods described herein can be performed by computer-executable instructions stored in one or more computer-readable media (e.g., storage or other tangible media) or one or more computer-readable storage devices.

### Example 5

### Exemplary Multi-Dimensional Auto-Scrolling Feature

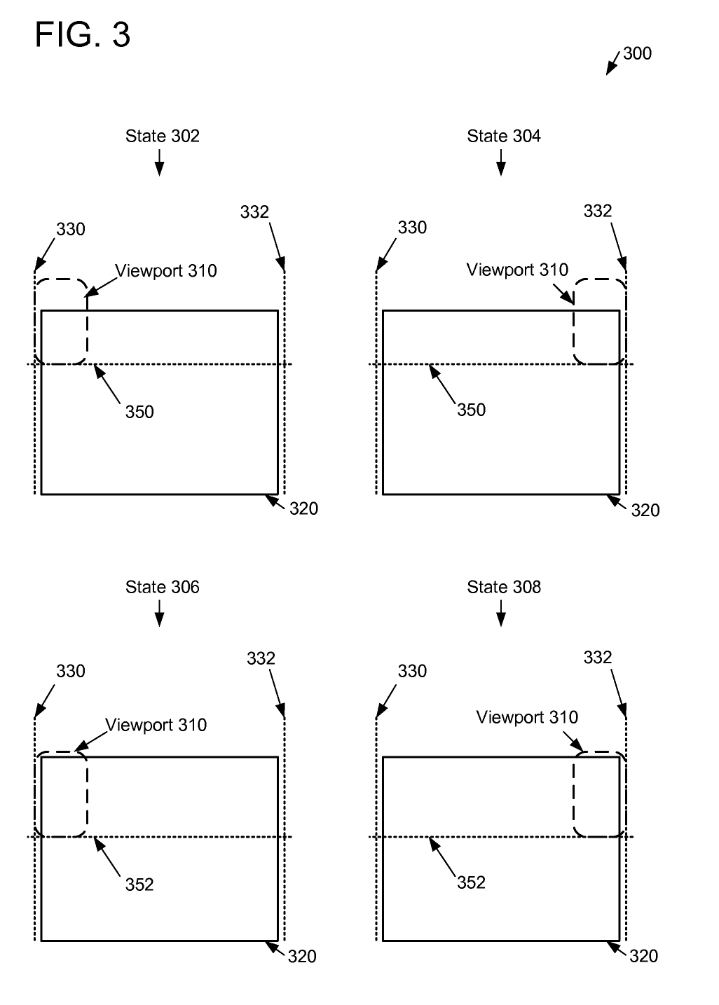

FIG. 3 is a conceptual diagram of an exemplary multi-dimensional auto-scrolling feature and can be implemented, for example, in a system such as that shown in FIG. 1. Any of the multi-dimensional auto-scrolling features described herein can be implemented in computer-executable instructions stored in one or more computer-readable media (e.g., storage or other tangible media) or one or more computer-readable storage devices.

In the example, state 302 shows a viewport 310 at the beginning of a horizontal scrolling cycle in which a portion of visual information 320 is displayed in a display area on a computing device. When a two-dimensional auto-scrolling movement is initiated, the viewport 310 is initially aligned at a horizontal scrolling cycle starting alignment 330 and a vertical alignment 350. In state 302, the alignments 330, 350 are such that the topmost, leftmost portion of the visual information 320 is visible in the viewport 310. Although the alignment 330 is referred to as a scrolling cycle starting alignment, the system actually can begin auto-scrolling at any position (e.g., from a position between a scrolling cycle starting alignment and a scrolling cycle ending alignment).

State 304 shows viewport 310 at the end of a horizontal scrolling cycle in which the visual information 320 has been scrolled such that viewport 310 is now aligned at a horizontal scrolling cycle ending alignment 332, while maintaining the vertical alignment 350. In the example, the topmost, rightmost portion of the visual information visual information 320 is visible in the viewport 310 at the end of the horizontal scrolling cycle. The two-dimensional auto-scrolling continues to state 306, which shows viewport 310 at the beginning of a second horizontal scrolling cycle after the visual information 320 has been returned to the horizontal scrolling cycle starting alignment 330 and shifted down to the shifted vertical alignment 352. The two-dimensional auto-scrolling continues to state 308, in which viewport 310 is now aligned at the horizontal scrolling cycle ending alignment 332, while maintaining the shifted vertical alignment 352. Two-dimensional auto-scrolling can continue in this manner until, for example, the end of the visual information is reached, or the two-dimensional auto-scrolling is modified in some way (e.g., by limiting the range of the horizontal scrolling, etc.), stopped or paused (e.g., in response to additional user input).

### Example 6

### Exemplary Alignment

In any of the examples herein, viewports, visual information, etc. can be described has having alignments. For example, a horizontal scrolling cycle starting alignment refers to a position at which a viewport aligns with visual information at the beginning of a horizontal scrolling cycle. Although some examples herein describe alignments in which particular edges of a viewport are aligned with visual information at particular positions, alignments can be defined in different ways. For example, referring again to FIG. 3, state 302 shows the left edge of a viewport 310 aligned at a horizontal scrolling cycle starting alignment 330 and the bottom edge of a viewport 310 aligned at a vertical alignment 350, at the beginning of a scrolling cycle. Alternatively, a horizontal scrolling cycle starting alignment can be defined as a position at which a right edge of a viewport, a midline between the left and right edges of a viewport, etc., will be aligned at the beginning of a scrolling cycle. As another alternative, a vertical alignment can be defined as a position at which a top edge of a viewport, a midline between the top and bottom edges of a viewport, etc., will be aligned (e.g., at the beginning of a scrolling cycle).

In any of the examples herein, any number of alignments in any dimension can be used, and alignments can be adjustable to suit user preferences, content arrangements, and the like.

### Example 7

### Exemplary Scrolling Cycle

In any of the examples herein, a scrolling cycle can include scrolling visual information from a scrolling cycle starting alignment to a first-dimension scrolling cycle ending alignment. A new scrolling cycle in a first dimension (e.g., a new horizontal scrolling cycle) typically begins at a first-dimension scrolling cycle starting alignment (e.g., a horizontal scrolling cycle starting alignment). For example, referring again to FIG. 3, state 306 shows the beginning of a new horizontal scrolling cycle after the content 320 has been returned (from state 304) to the horizontal scrolling cycle starting alignment 330 and shifted down to the shifted vertical alignment 352. Although some alignments are described herein as scrolling cycle starting alignments, the multi-dimensional auto-scrolling technologies described herein actually can be initiated at any position (e.g., from a position between a cycle starting alignment and a cycle ending alignment). Typically, once multi-dimensional auto-scrolling is initiated, new scrolling cycles will begin at scrolling cycle starting alignments.

The movement of visual information during a scrolling cycle can be presented in different ways. For example, in a horizontal scrolling cycle, a multi-dimensional auto-scrolling system can scroll visual information from left to right or from right to left (e.g., depending on user preference, the language of text in the content being viewed, etc.), although for consistency individual scrolling cycles in a multi-dimensional auto-scrolling session will typically move in the same direction (e.g., to simulate the movement of human eyes while reading).

In any of the examples herein, scrolling cycles can be adjustable to suit user preferences, device characteristics (e.g., display characteristics), and the like.

### Example 8

### Exemplary Transition Between Scrolling Cycles

The movement of the visual information when transitioning from the end of a scrolling cycle to the beginning of a new scrolling cycle (e.g., from a position at a first-dimension scrolling cycle ending alignment and a second-dimension alignment to a position at a first-dimension scrolling cycle starting alignment and a shifted, second-dimension alignment) can be presented in different ways. For example, a multi-dimensional auto-scrolling system can animate the transition with a diagonal scrolling motion, a horizontal scrolling motion followed by a vertical scrolling motion, etc. Or, a multi-dimensional auto-scrolling system can cause the visual information to jump directly to the appropriate position for the next scrolling cycle (e.g., a position at a horizontal starting alignment and a shifted vertical alignment) without scrolling during the transition. Such a jump can be combined with blending effects, fade-in/fade-out effects, or the like, for a smoother visual transition. A multi-dimensional auto-scrolling system also can briefly pause after the transition before starting the next cycle of scrolling to allow a user to adapt to the new position of the visual information.

In any of the examples herein, transitions between scrolling cycles can be adjustable to suit user preferences, device characteristics (e.g., display characteristics), and the like.

### Example 9

### Exemplary System Employing a Combination of the Technologies

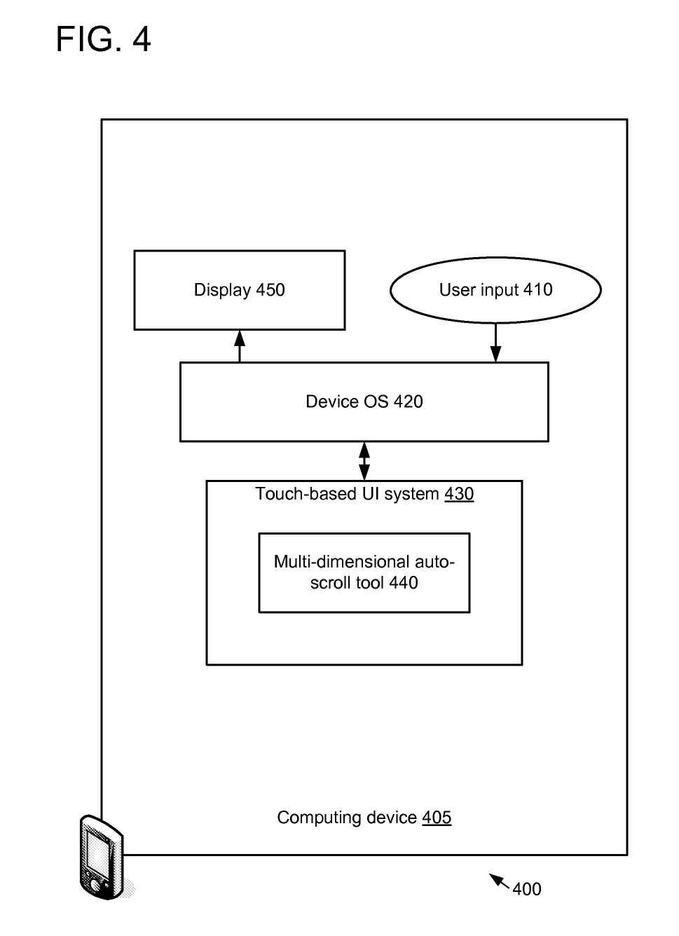

FIG. 4 is a block diagram of another exemplary system 400 implementing multi-dimensional auto-scroll technologies described herein. In the example, one or more computing devices 405 implement a multi-dimensional auto-scroll tool 420 that accepts user input 410 to initiate a multi-dimensional auto-scroll movement in content presented to the user on display 450. The user input 410 can include touch-based user input, such as one or more gestures on a touchscreen. In the example, a device operating system (OS) receives touch-based user input information (e.g., gesture information such as velocity, direction, etc.), interprets it, and forwards the interpreted touch-based user input information to touch-based user interface (UI) system 430, which includes the multi-dimensional auto-scroll tool 420. The touch-based UI system 430, via the multi-dimensional auto-scroll tool 420, determines how multi-dimensional auto-scrolling movement should be presented. The touch-based UI system forwards multi-dimensional auto-scrolling information to the device OS 420, which sends rendering information to the display 450.

In practice, the systems shown herein such as system 400 can be more complicated, with additional functionality, more complex relationships between system components, and the like. The technologies described herein can be generic to the specifics of operating systems or hardware and can be applied in any variety of environments to take advantage of the described features.

### Example 10

### Exemplary Gesture

In any of the examples herein, user input can include one or more gestures on a touchscreen. A touch-based user interface UI system such as system 430 in FIG. 4 can accept input from one or more contact points on a touchscreen and use the input to determine what kind of gesture has been made. For example, a touch-based UI system 430 can distinguish between different gestures on the touchscreen, such as pan gestures and flick gestures, based on gesture velocity. When a user touches the touchscreen and begins a movement in a horizontal direction while maintaining contact with the touchscreen, touch-based UI system 430 can continue to fire inputs while the user maintains contact with the touchscreen and continues moving. The position of the contact point can be updated, and the rate of movement (velocity) can be monitored. When the physical movement ends (e.g., when user breaks contact with the touchscreen), the system can determine whether to interpret the motion as a flick by determining how quickly the user's finger, stylus, etc., was moving when it broke contact with the touchscreen, and whether the rate of movement exceeds a threshold. The threshold velocity for a flick to be detected (i.e., to distinguish a flick gesture from a pan gesture) can vary depending on implementation.

In the case of a pan gesture, the system can move content in the amount of the pan (e.g., to give an impression of the content being moved directly by a user's finger). In the case of a flick gesture (e.g., where the user was moving more rapidly when the user broke contact with the touchscreen), the system can use simulated inertia to determine a post-gesture position for the content, allowing the content to continue to move after the gesture has ended. Although gestures such as pan and flick gestures are commonly used to cause movement of content in a display area, such gestures also can be accepted as input for other purposes without causing any direct movement of content.

A touch-based system also can detect a tap or touch gesture, such as where the user touches the touchscreen in a particular location, but does not move the finger, stylus, etc. before breaking contact with the touchscreen. As an alternative, some movement is permitted, within a small threshold, before breaking contact with the touchscreen in a tap or touch gesture. A touch-based system also can detect multi-touch gestures made with multiple contact points on the touchscreen.

Depending on implementation and/or user preferences, gesture direction can be interpreted in different ways. For example, a device can interpret any movement to the left or right, even diagonal movements extending well above or below the horizontal plane, as a valid leftward or rightward motion, or the system can require more precise movements. As another example, a device can interpret any upward or downward movement, even diagonal movements extending well to the right or left of the vertical plane, as a valid upward or downward motion, or the system can require more precise movements. As another example, upward/downward motion can be combined with left/right motion for diagonal movement effects.

The actual amount and direction of the user's motion that is necessary to for a device to recognize the motion as a particular gesture can vary depending on implementation or user preferences. For example, a user can adjust a touchscreen sensitivity control, such that differently sized or shaped motions of a fingertip or stylus on a touchscreen will be interpreted as the same gesture to produce the same effect, or as different gestures to produce different effects, depending on the setting of the control.

The gestures described herein are only examples. In practice, any number of different gestures can be used when implementing the technologies described herein. Described techniques and tools can accommodate gestures of any size, velocity, or direction, with any number of contact points on the touchscreen.

### Example 11

### Exemplary Multi-Dimensional Gesture

In any of the examples described herein, a multi-dimensional gesture is a gesture on a touchscreen that includes motion in a first dimension (e.g., a horizontal dimension) and motion in a second dimension (e.g., a vertical dimension). Typically, the motion in the multi-dimensional gesture will occur without breaking contact with the touchscreen. However, a combination of gestures (e.g., a gesture in one dimension followed by a gesture in another dimension) that each end with breaking contact with the touchscreen also can be interpreted as a single multi-dimensional gesture (e.g., where the period of time in which a user's finger or stylus is not in contact with the touchscreen is relatively short). A multi-dimensional gesture also can occur in touchscreen configurations in which actual physical contact with the touchscreen is not required.

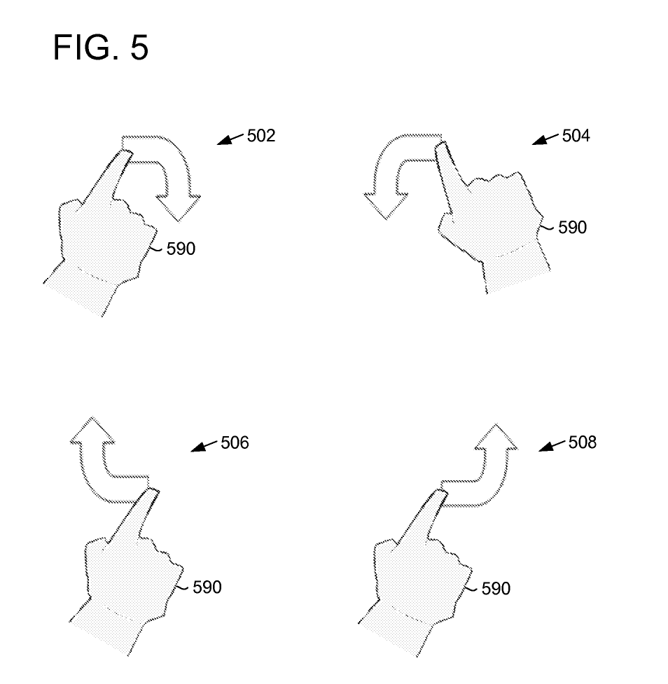

FIG. 5 is a diagram of several exemplary multi-dimensional gestures. Gesture 502 is a right-and-down gesture (a rightward motion followed by a downward motion), gesture 504 is a left-and-down gesture (a leftward motion followed by a downward motion), gesture 506 is a left-and-up gesture (a leftward motion followed by an upward motion), and gesture 508 is a right-and-up gesture (a leftward motion followed by an upward motion). The gestures 502-508 are shown being performed by a user 590. Although the example gestures 502-508 include a rounded corner between the horizontal motion and the vertical motion, multi-dimensional gestures also can include sharper corners, or even more rounded corners between the horizontal motion and the vertical motion. Although the example gestures 502-508 include horizontal motion followed by vertical motion, multi-dimensional gestures also can include vertical motion followed by horizontal motion, or other combinations of motion. For example, multi-dimensional gestures can include diagonal motion, curved motion, and the like.

Different multi-dimensional gestures can be interpreted in different ways. On the other hand, separate instances of the same multi-dimensional gesture can be interpreted in different ways, such as when the same gesture is used in different contexts. Examples uses and interpretations of gestures 502-508 are described in other examples herein.

Described techniques and tools can accommodate multi-dimensional gestures of any size, velocity, or direction.

### Example 12

### Exemplary Auto-Scroll Engage Gesture

In any of the examples described herein, a multi-dimensional gesture can be used to engage multi-dimensional auto-scrolling. For example, referring again to FIG. 5, gesture 502 can be used to engage multi-dimensional auto-scrolling that mimics left-to-right, top-to-bottom reading movement, and gesture 504 can be used to engage multi-dimensional auto-scrolling that mimics right-to-left, top-to-bottom reading movement. Other example uses for the gestures 502 and 504-508 are described in other examples herein.

Although some of the examples described herein use multi-dimensional gestures to engage multi-dimensional auto-scrolling, other gestures (e.g., one-dimensional gestures such as horizontal gestures or vertical gestures, tap gestures, etc.) also can be used. Described techniques and tools can use gestures of any size, velocity, or direction, or other user input (such as pressing one or more buttons on a device such as an electronic book reader), to engage multi-dimensional auto-scrolling.

### Example 13

### Exemplary Scrolling Speed

In any of the examples described herein, multi-dimensional auto-scrolling can proceed according to a scrolling speed. A scrolling speed can refer to, for example, the speed at which visual information is scrolled in a first dimension during a first-dimension scrolling cycle (e.g., a horizontal scrolling speed for left-to-right or right-to-left reading movement during a horizontal scrolling cycle). Typically, a scrolling speed is set to a readable speed, that is, a speed that will allow a user to read or otherwise cognitively monitor the content being viewed. Scrolling speeds can be adjustable. For example, a user can set a default reading speed to be used when multi-dimensional auto-scrolling is first engaged. As another example, a user can adjust scrolling speeds while scrolling is in progress. Exemplary techniques for adjusting scrolling speeds are described in other examples herein. As another example, eye-tracking technology can be used to determine how fast a user is reading, and adjust scrolling speed accordingly. Described techniques and tools can scroll visual information at any scrolling speed, and can use any type of fine or coarse speed controls.

### Example 14

### Exemplary Method of Applying a Combination of the Technologies

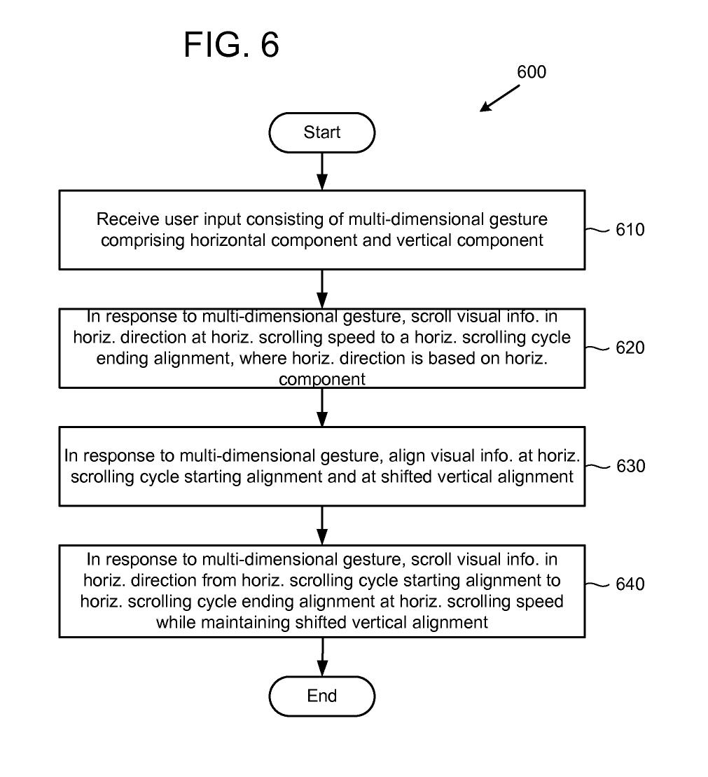

FIG. 6 is a flowchart of an exemplary method 600 of implementing the multi-dimensional auto-scrolling technologies described herein and can be implemented, for example, in a system such as that shown in FIG. 4.

At 610, the system receives user input consisting of a multi-dimensional gesture comprising a horizontal component and a vertical component, and at 620, in response to the multi-dimensional gesture the system scrolls visual information (e.g., a web page, a document, etc.) in a horizontal direction at a horizontal scrolling speed to a horizontal scrolling cycle ending alignment. At 630, in response to the multi-dimensional gesture the visual information is aligned at a horizontal scrolling cycle starting alignment and at a shifted vertical alignment. At 640, in response to the multi-dimensional gesture the visual information is scrolled from the horizontal scrolling cycle starting alignment to the horizontal scrolling cycle ending alignment at the horizontal scrolling speed while maintaining the shifted vertical alignment.

### Example 15

### Exemplary Multi-Dimensional Auto-Scrolling Feature

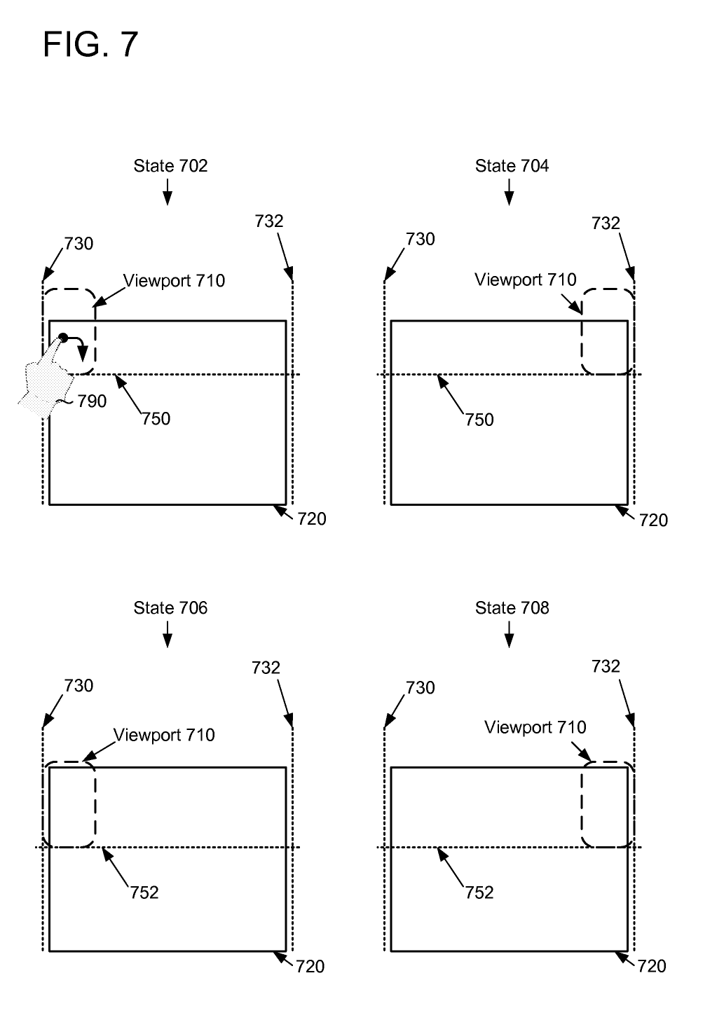

FIG. 7 is a conceptual diagram of an exemplary multi-dimensional auto-scrolling feature and can be implemented, for example, in a system such as that shown in FIG. 4. In the example, state 702 shows a viewport 710 at the beginning of a horizontal scrolling cycle in which a portion of visual information 720 is displayed in a display area on a computing device. A user 790 uses a multi-dimensional gesture to engage a two-dimensional auto-scrolling movement. In this example, the multi-dimensional gesture is a right-and-down gesture (a rightward motion followed by a downward motion). The viewport 710 is initially aligned at a horizontal starting scrolling cycle alignment 730 and a vertical alignment 750. In state 702, the topmost, leftmost portion of the visual information 720 is visible in the viewport 710.

State 704 shows viewport 710 at the end of a horizontal scrolling cycle in which the visual information 720 has been scrolled such that the right edge of viewport 710 is now aligned at a horizontal scrolling cycle ending alignment 732, while maintaining the vertical viewport alignment 750. In the example, the topmost, rightmost portion of the visual information 720 is visible in the viewport 710 at the end of the horizontal scrolling cycle. The two-dimensional auto-scrolling continues to state 706, which shows viewport 710 at the beginning of a second horizontal scrolling cycle, after the visual information 720 has been returned to the horizontal scrolling cycle starting alignment 730 and shifted down to the shifted vertical alignment 752. The two-dimensional auto-scrolling continues to state 708, in which viewport 710 is now aligned at the horizontal scrolling cycle ending alignment 732, while maintaining the shifted vertical alignment 752. Two-dimensional auto-scrolling can continue in this manner until, for example, the end of a page is reached, or the two-dimensional auto-scrolling is modified in some way (e.g., by limiting the range of the horizontal scrolling, etc.), stopped or paused (e.g., in response to additional user input).

### Example 16

### Exemplary End Boundary

In any of the examples described herein, an end boundary indicates a stopping point for multi-dimensional auto scrolling. An end boundary can be at any position in content. Typically, an end boundary marks a position at end of the visual information being viewed, or a particular part of visual information (e.g., visual information selected by a user, such as a text block on a web page). End boundaries can be visible or remain hidden during scrolling. End boundaries can be set by default (e.g., at the bottom right of a web page), or selected by a user. For example, a user can select a point half-way through an article at which multi-dimensional auto-scrolling should stop. Multi-dimensional auto-scrolling can be resumed, if appropriate, when an end boundary is reached, such as when viewable content is available on a page beyond the end boundary. When a page being scrolled reaches the end of its scroll range as indicated by an end boundary, the multi-dimensional auto-scrolling mode can be disengaged without further user input, allowing the user to perform other tasks. Described techniques and tools can use end boundaries at any position in content, and can even use more than one end boundary on the same page. Typically, content will include at least one end boundary to prevent endless scrolling, but end boundaries are not required.

### Example 17

### Exemplary Orthogonal Displacement

In any of the examples described herein, a scrolling cycle that involves scrolling visual information in a first direction (e.g., a horizontal direction) can be followed by a shift of the visual information in a second direction orthogonal to the first direction (e.g., a vertical direction). The shift can be quantified as an orthogonal displacement (e.g., a vertical displacement). An orthogonal displacement can be of any magnitude. Typically, an orthogonal displacement of one unit is made after each scrolling cycle, where the unit depends on the visual information being scrolled. For example, when a block of text is being scrolled, the unit can be equivalent to the height of a line of text. As another example, when a collection of application icons is being scrolled (e.g., when a user is selecting an application to launch or purchase), the unit can be equivalent to the height of a row of application icons. Orthogonal displacement can be set by default (e.g., based on font size in a block of text, image size in a collection of images, etc.), or determined in some other way, such as by user selection. Described techniques and tools can use orthogonal displacements of any size, and can even use more than one displacement size in the same scrolling session (e.g., where different font sizes are used in a block of text).

### Example 17

### Exemplary Text Metrics and Zoom Effects

In any of the examples described herein, multi-dimensional auto-scrolling can depend on text metrics and/or zoom effects. For example, a scrolling cycle that involves scrolling text in a first direction (e.g., a horizontal direction) can be affected by text metrics (e.g., the size of the text at a 100% zoom level) and whether a user has zoomed in or out on the text to make the zoom level greater than or less than 100%. Where text is made larger or smaller relative to the size of the viewport, such as when a user has zoomed in on the content, the distance covered in a scrolling cycle also can increase or decrease accordingly. A shift of the text in a second direction orthogonal to the first direction (e.g., a vertical direction) also can be affected by text metrics and whether a user has zoomed in or out on the text. For example, where a line of text is made larger or smaller relative to the size of the viewport due to zooming in or out, the distance covered in an orthogonal displacement also can increase or decrease accordingly. Described techniques and tools can be used with any size of text and any level of zoom, and can even use more than one size of text or zoom level in the same scrolling session (e.g., where a user increases or decreases a zoom level during auto-scrolling, or where different font sizes are used in a block of text). Zoom effects also can be used when auto-scrolling visual information other than text, such as images or graphics.

### Example 18

### Exemplary Repetition for Continuous Auto-Scrolling

In any of the examples described herein, acts such as aligning and shifting can be repeated (e.g., for continuous multi-dimensional auto-scrolling). For example, at the end of a horizontal scrolling cycle, upon reaching a horizontal scrolling cycle ending alignment, visual information can be aligned at a shifted vertical alignment and a horizontal scrolling cycle starting alignment to begin a new scrolling cycle. For further auto-scrolling, the aligning (horizontal and vertical) and the scrolling from the starting alignment to the ending alignment can be repeated (e.g., until an end boundary is reached or the scrolling is stopped in response to further events or user input).

### Example 19

### Exemplary Method of Applying a Combination of the Technologies

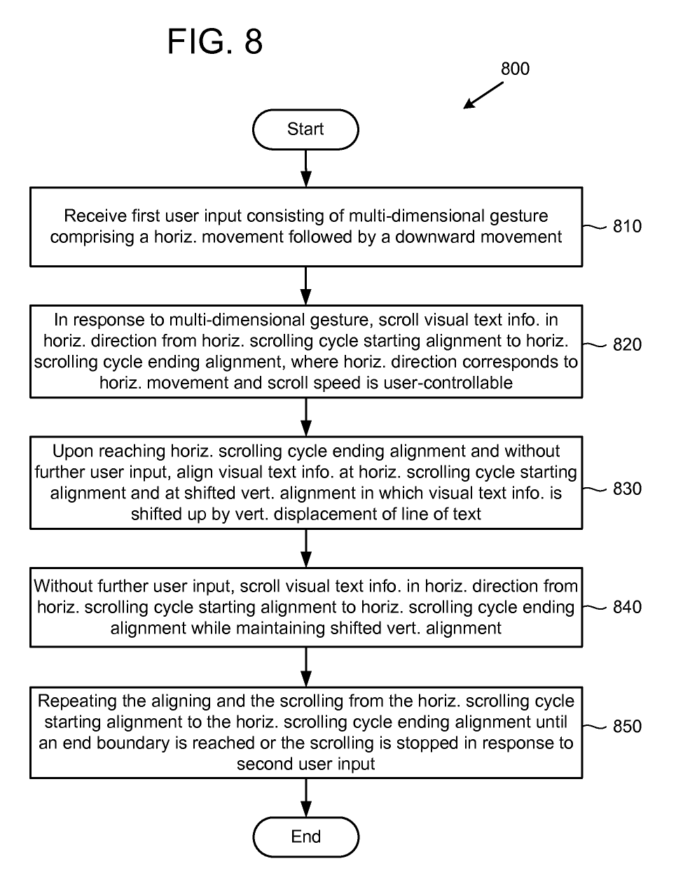

FIG. 8 is a flowchart of an exemplary method 800 of implementing the multi-dimensional auto-scrolling technologies described herein and can be implemented, for example, in a system such as that shown in FIG. 4.

At 810, the system receives a multi-dimensional gesture comprising a horizontal movement and a downward movement, and at 820, in response to the multi-dimensional gesture the system scrolls visual text information (e.g., text on a web page, text in a document, etc.) in a horizontal direction at a horizontal scrolling speed from a horizontal scrolling cycle starting alignment to a horizontal scrolling cycle ending alignment. The horizontal direction of the scrolling corresponds to the horizontal movement in the gesture. For example, to drive the visual text information in a direction that corresponds to left-to-right reading, the multi-dimensional gesture comprises a rightward movement and a downward movement. As another example, to drive the visual text information in a direction that corresponds to right-to-left reading, the multi-dimensional gesture comprises a leftward movement and a downward movement.

At 830, upon reaching the horizontal scrolling cycle ending alignment and without further user input, the visual text information is aligned at the horizontal scrolling cycle starting alignment and at a shifted vertical alignment in which the visual text information is shifted up by a vertical displacement of a line of text in the visual text information. Although a viewport may display text from more than one line, shifting by a vertical displacement of a line of text after a horizontal scrolling cycle allows a user to read line-by-line. At 840, without further user input the visual text information is scrolled from the horizontal scrolling cycle starting alignment to the horizontal scrolling cycle ending alignment while maintaining the shifted vertical alignment. At 850, the aligning and the scrolling from the horizontal scrolling cycle starting alignment to the horizontal scrolling cycle ending alignment is repeated until an end boundary (e.g., a boundary positioned at the end of the last line of a block of text) is reached or the scrolling is stopped in response to second user input (e.g., a gesture that disengages the multi-dimensional auto-scrolling.)

### Example 20

### Exemplary Multi-Dimensional Auto-Scrolling Feature

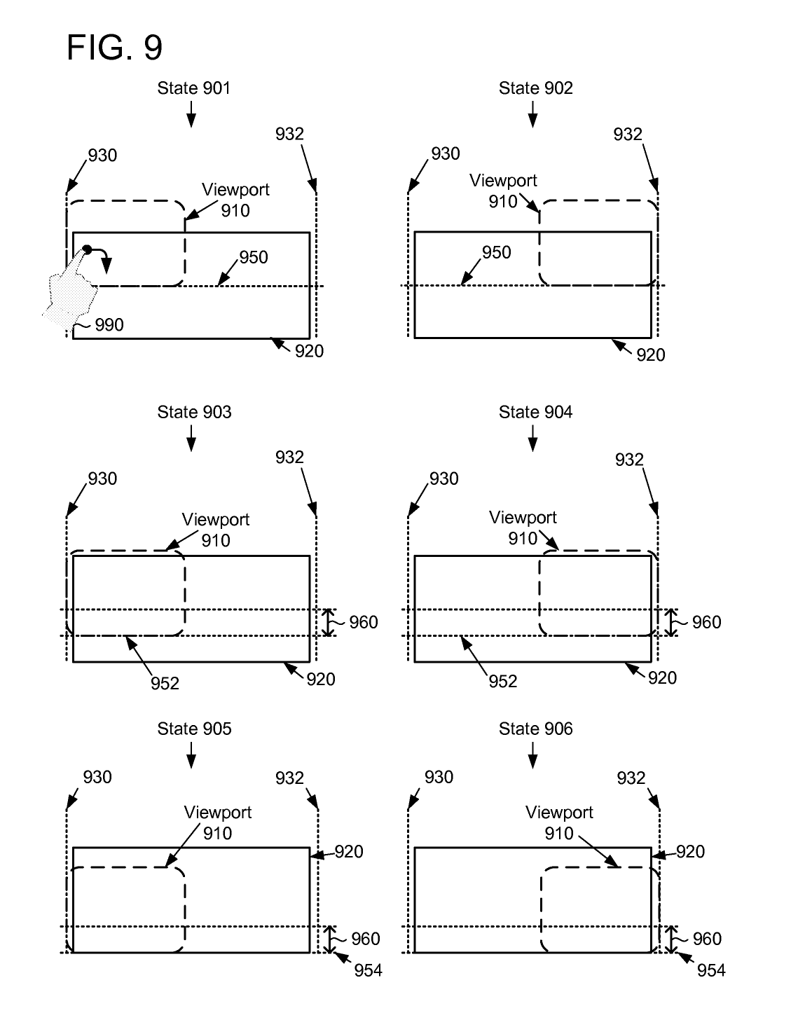

FIG. 9 is a conceptual diagram of an exemplary multi-dimensional auto-scrolling feature and can be implemented, for example, in a system such as that shown in FIG. 4. In the example, state 901 shows a viewport 910 at the beginning of a horizontal scrolling cycle in which a portion of text content 920 is displayed in a display area on a computing device. A user 990 uses a multi-dimensional gesture comprising a rightward movement followed by a downward movement to engage a two-dimensional auto-scrolling movement of the text content. The viewport 910 is initially aligned at a horizontal scrolling cycle starting alignment 930 and a vertical alignment 950. In state 901, the topmost, leftmost portion of the text content 920 is visible in the viewport 910.

State 902 shows viewport 910 at the end of a horizontal scrolling cycle in which the text content 920 has been scrolled (without any further user input) such that the right edge of viewport 910 is now aligned at a horizontal scrolling cycle ending alignment 932, while maintaining the vertical alignment 950. In the example, the topmost, rightmost portion of the text content 920 is visible in the viewport 910 at the end of the horizontal scrolling cycle. The two-dimensional auto-scrolling continues to state 903, which shows viewport 910 at the beginning of a second horizontal scrolling cycle after the text content 920 has been returned (without any further user input) to the horizontal scrolling cycle starting alignment 930 and shifted down by a displacement 960 of a line of text to a shifted vertical alignment 952. The two-dimensional auto-scrolling continues to state 904 (without any further user input), in which viewport 910 is now aligned at the horizontal scrolling cycle ending alignment 932, while maintaining the shifted vertical alignment 952. Two-dimensional auto-scrolling can continue in this manner until, for example, an end boundary is reached, or the two-dimensional auto-scrolling is modified in some way (e.g., by limiting the range of the horizontal scrolling, etc.), stopped or paused (e.g., in response to additional user input). In this example, the two-dimensional auto-scrolling continues to state 905, which shows viewport 910 at the beginning of a third horizontal scrolling cycle after the text content 920 has been returned (without any further user input) to the horizontal scrolling cycle starting alignment 930 and shifted down by a displacement 960 of a line of text to the second shifted vertical alignment 954. The two-dimensional auto-scrolling continues to state 906 (without any further user input), in which viewport 910 is now aligned at the horizontal scrolling cycle ending alignment 932, while maintaining the second shifted vertical alignment 954. At state 906, the two-dimensional auto-scrolling stops because an end boundary (not shown) at the end of the text content 920 has been reached.

### Example 21

### Exemplary Viewable Web Page

In any of the examples herein, a viewable web page can include any collection of visual information (e.g., text, images, embedded video clips, animations, graphics, interactive information such as hyperlinks or user interface controls, etc.) that is viewable in a web browser. Although the techniques and tools described herein are designed to be used to assist in presenting visual information, the techniques and tools described herein can be used effectively with web pages that also include other content, such as information that is not intended to be presented to a user (e.g., scripts, metadata, style information) or information that is not visual, such as audio information.

The viewable web page typically results from compilation of source code such as markup language source code (e.g., HTML, XHTML, DHTML, XML). However, web page source code also may include other types of source code such as scripting language source code (e.g., Javascript) or other source code. The technologies described herein can be implemented to work with any such source code.

### Example 22

### Exemplary Multi-Dimensional Auto-Scrolling Feature

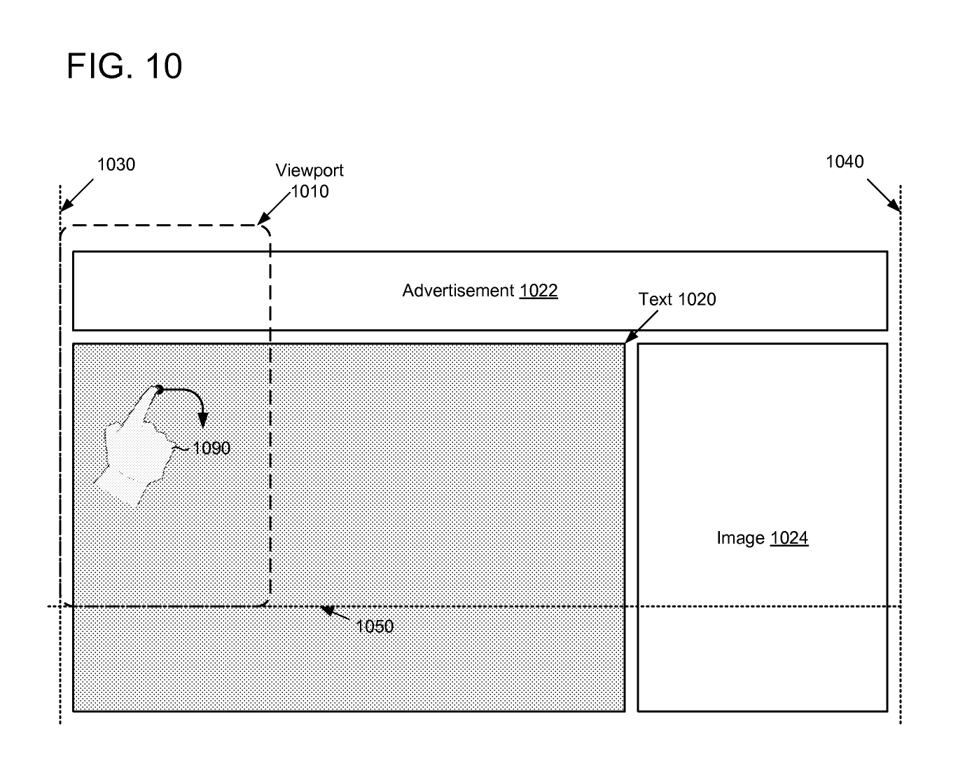

FIG. 10 is a conceptual diagram of an exemplary multi-dimensional auto-scrolling feature and can be implemented, for example, in a system such as that shown in FIG. 4. In the example, content on a viewable web page includes text 1020, an advertisement 1022, and an image 1024 associated with the text 1020. Viewport 1010 is shown at the beginning of a horizontal scrolling cycle in which a portion of the text 1020 is displayed along with a portion of advertisement 1022. A user 1090 uses a multi-dimensional gesture comprising a rightward movement followed by a downward movement to begin two-dimensional auto-scrolling movement of the content. The left edge of the viewport 1000 is aligned at a horizontal scrolling cycle starting alignment 1030, and the bottom edge of the viewport is aligned at a vertical alignment 1050. A default horizontal scrolling cycle ending alignment 1040 to the right of the image 1024 also is shown. Although a user may wish to scroll all the way to the edge of the image 1024, a user may also wish to adjust the scrolling cycle ending alignment to focus on some other content, such as the text 1020.

### Example 23

### Exemplary Scrolling Cycle Alignment Updates

In any of the examples herein, scrolling cycle alignments can be adjusted. For example, if a user notices that auto-scrolling is causing a web page to scroll beyond content (e.g., a news article) that is of interest to a user to content that is of less interest (e.g., advertising), the user can adjust a scrolling cycle ending boundary to focus on the content the user is interested in. Such adjustments can be referred to as scrolling cycle alignment updates. For example, during multi-dimensional auto-scrolling, a user can update a scrolling cycle ending alignment by making a gesture on a touchscreen. Such gestures can include a flick gesture in which a user makes a motion in the opposite direction of the scrolling motion. For example, a leftward flick gesture can be used during left-to-right reading movement to update a horizontal scrolling cycle ending alignment. Typically, an update to a scrolling cycle ending alignment will end the current scrolling cycle and start a new one (e.g., at a vertically shifted alignment), and the new scrolling cycle and future scrolling cycles will end at the updated alignment. The update can correspond to a position of some part of a viewport at the time a gesture (or other user input) is received. For example, a leftward flick gesture used during left-to-right reading movement can cause a horizontal scrolling cycle ending alignment to be set at the position of the right edge of the viewport. Updates can be relative to a default alignment or a previously updated alignment. Updates can be discarded. For example, after a horizontal scrolling cycle ending alignment has been updated in response to a leftward flick gesture, the update can be discarded in response to a rightward flick gesture. Discarding an update can reinstate a default alignment that was previously superseded by the update. Updates can be made to all types of alignments, including starting and ending alignments for horizontal scrolling cycles, and starting and ending alignments for vertical scrolling cycles.

The technologies described herein can accept any kind of user input, including gestures of all kinds, to update scrolling cycle alignments. The technologies described herein can accept any number of updates, at any position, in any dimension.

### Example 24

### Exemplary Multi-Dimensional Auto-Scrolling Feature

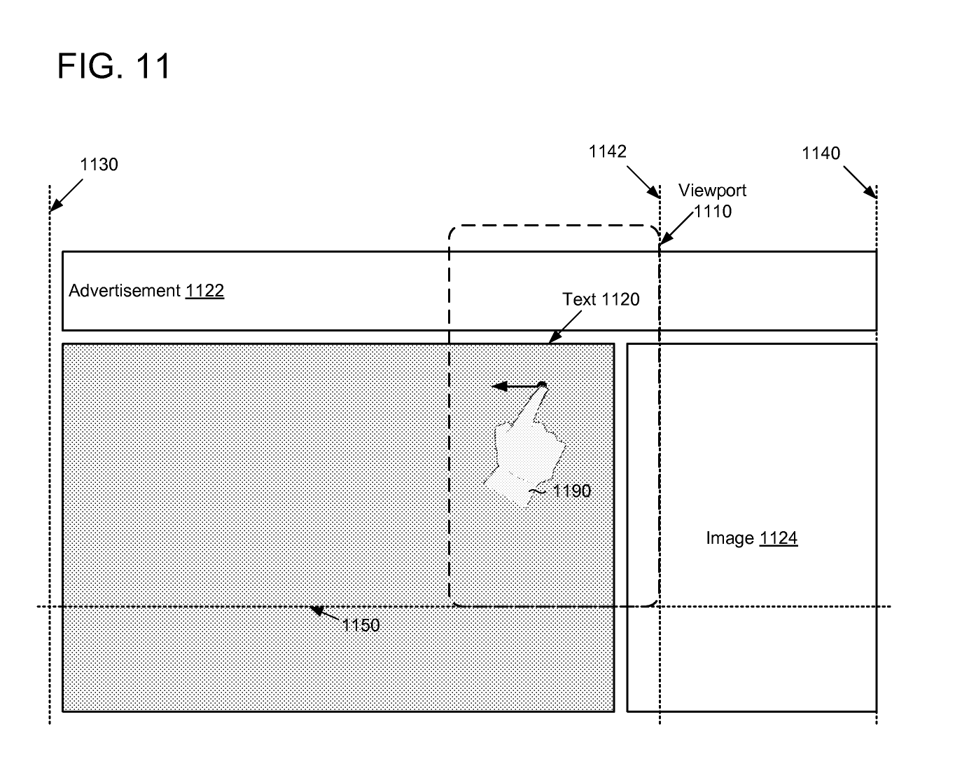

FIG. 11 is a conceptual diagram of an exemplary multi-dimensional auto-scrolling feature and can be implemented, for example, in a system such as that shown in FIG. 4. In the example, content on a viewable web page includes text 1120, an advertisement 1122, and an image 1124 associated with the text 1120. Viewport 1110 is shown with its right edge aligned at an updated horizontal scrolling cycle ending alignment 1142. A portion of the text 1120 is displayed in the viewport 1110 along with a portion of the advertisement 1122 and a portion of the image 1124. A user 1190 uses a leftward gesture (e.g., a flick gesture) to update a default horizontal scrolling cycle ending alignment 1140. The update can be made for any number of reasons, such as to maintain focus on the text 1120, rather than the image 1124. The bottom edge of the viewport 1110 is aligned at vertical alignment 1150. A horizontal scrolling cycle starting alignment 1130 also is shown.

### Example 25

### Exemplary Scrolling Speed Control Gesture

In any of the examples herein, scrolling speed can be controlled and adjusted. If a user notices that horizontal scrolling is moving too fast or two slow, the user can adjust the horizontal scrolling speed. For example, during multi-dimensional auto-scrolling, a user can adjust scrolling speed by making a gesture on a touchscreen. Speed-increasing gestures can include a gesture that matches a gesture used to start the auto-scrolling (e.g., a multi-dimensional gesture). For example, a right-and-down gesture can be used during left-to-right reading movement, or a left-and-down gesture can be used during right-to-left reading movement, to increase horizontal scrolling speed. Speed-decreasing gestures can include a gesture that opposes a gesture used to start the auto-scrolling (e.g., a multi-dimensional gesture). For example, a left-and-up gesture can be used during left-to-right reading movement, or a right-and-up gesture can be used during right-to-left reading movement, to decrease horizontal scrolling speed. If a scrolling speed is already at a minimum speed, a speed-decreasing gesture can cause scrolling to stop completely. If scrolling has already been stopped, attempts to decrease scrolling speed can be ignored.

Adjustments to scrolling speed can be relative to a default speed or a previously adjusted speed. For example, a gesture can be used to increase scrolling speed and then can be repeated to further increase the scrolling speed. Successive speed-increasing gestures can further increase the speed at a constant rate or at an increasing or decreasing rate. As another example, a gesture can be used to increase scrolling speed and then an opposing gesture can be used to return the scrolling speed to its previous value. Scrolling speeds can be limited or unlimited. For example, scrolling speeds can be limited to a speed at which most humans can read. If a scrolling speed is limited, attempts to increase the scrolling speed beyond the limit can be ignored. A scrolling speed setting can be indicated with additional visual feedback, but in the typical case the speed at which the content is moving will be sufficient feedback for a user to know the speed setting.

Updates can be made to all types of scrolling speeds, including scrolling speeds for horizontal scrolling cycles and scrolling speeds for vertical scrolling cycles. The technologies described herein can accept any kind of user input, including gestures of all kinds, to update scrolling speeds. The technologies described herein can accept any number of scrolling speed adjustments, at any position.

### Example 26

### Exemplary Multi-Dimensional Auto-Scrolling Feature

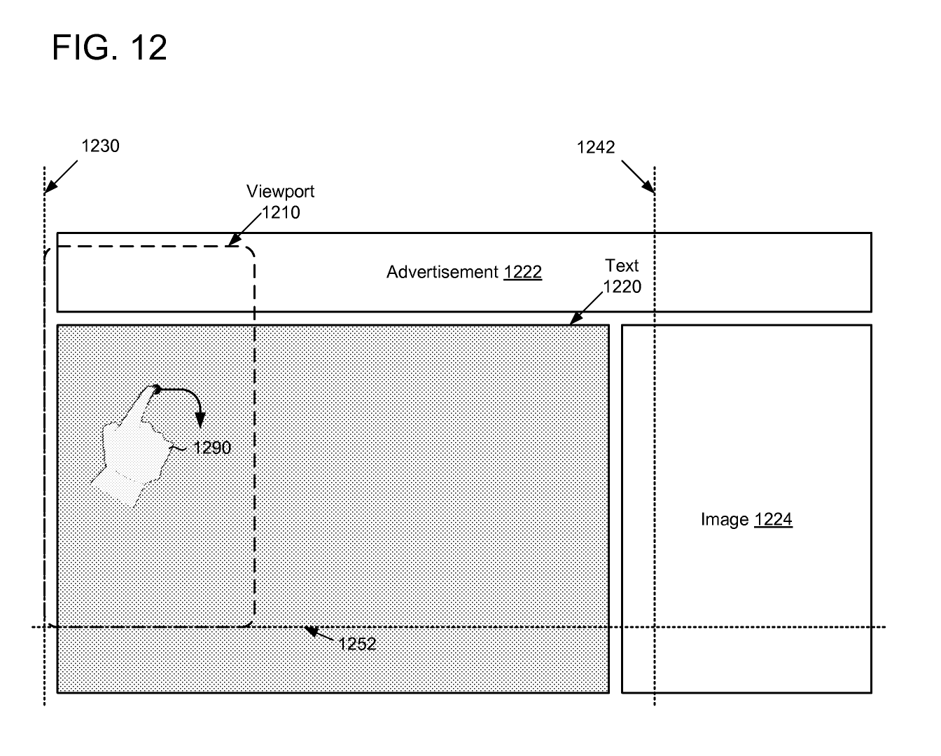

FIG. 12 is a conceptual diagram of an exemplary multi-dimensional auto-scrolling feature and can be implemented, for example, in a system such as that shown in FIG. 4. In the example, content on a viewable web page includes text 1220, an advertisement 1222, and an image 1224 associated with the text 1220. Viewport 1210 is shown at the beginning of a new horizontal scrolling cycle, with its left edge aligned at a horizontal scrolling cycle starting alignment 1230. (Multi-dimensional auto-scrolling has already been started.) A portion of the text 1220 is displayed in the viewport 1210 along with a portion of the advertisement 1222. A user 1290 uses a multi-dimensional gesture comprising a rightward movement followed by a downward movement to increase scrolling speed. The bottom edge of the viewport is aligned at a vertical alignment 1252. An updated horizontal scrolling cycle ending alignment 1242 also is shown.

### Example 27

### Exemplary Auto-Scroll Stop

In any of the examples herein, multi-dimensional auto-scrolling can be stopped in response to user input or other events. For example, a user can stop auto-scrolling movement by making a gesture on a touchscreen. Stop gestures can include a gesture that opposes a gesture used to start the auto-scrolling (e.g., a multi-dimensional gesture). For example, a left-and-up gesture can be used during left-to-right reading movement, or a right-and-up gesture can be used during right-to-left reading movement, to stop scrolling movement. The same gestures also can be used to decrease scrolling speed. If a scrolling speed is already at a minimum speed, a speed-decreasing gesture can cause scrolling to stop. If scrolling has already been stopped, further stop gestures can be ignored. Scrolling that has been stopped can be subsequently restarted at the position the content was in when scrolling was stopped, or at some other position. The technologies described herein can accept any kind of user input, including gestures of all kinds, to stop auto-scrolling. For example, a tap-and-hold gesture can be used in place of, or in addition to multi-dimensional gestures to stop auto-scrolling. Auto-scrolling also can be stopped in response to other events without user input. For example, auto-scrolling can be stopped when an end boundary is reached, or when other events occur such as incoming phone calls, low battery warnings, power-save modes, etc.

### Example 28

### Exemplary Multi-Dimensional Auto-Scrolling Feature

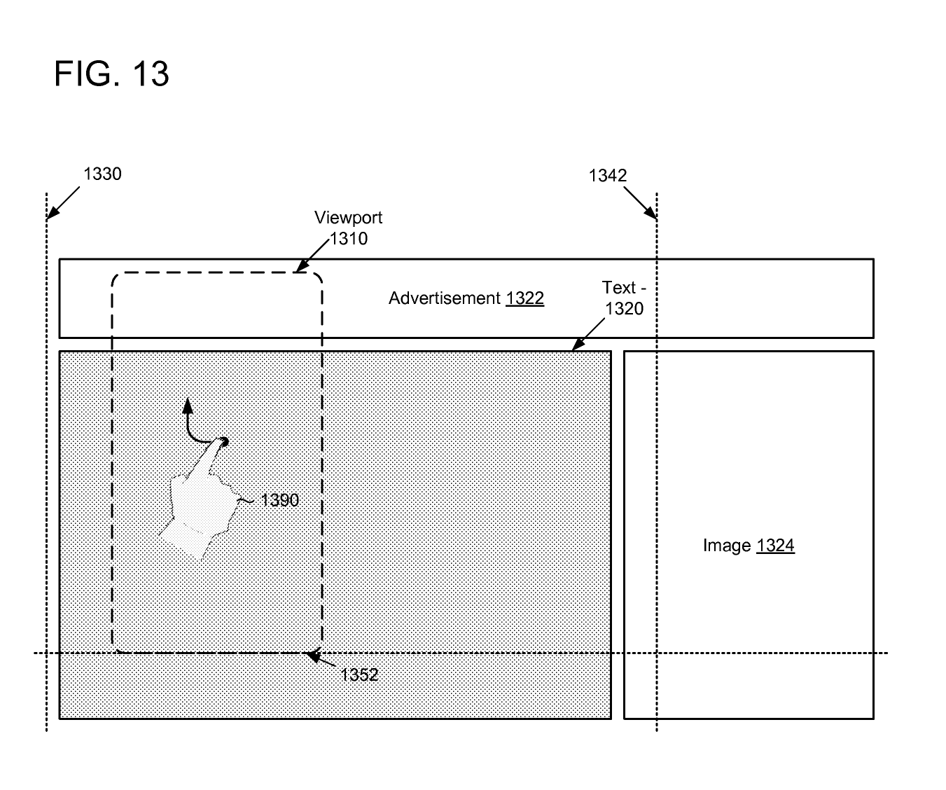

FIG. 13 is a conceptual diagram of an exemplary multi-dimensional auto-scrolling feature and can be implemented, for example, in a system such as that shown in FIG. 4. In the example, content on a viewable web page includes text 1320, an advertisement 1322, and an image 1324 associated with the text 1320. Viewport 1310 is shown at an intermediate points in a horizontal scrolling cycle, between horizontal scrolling cycle starting alignment 1330 and an updated horizontal scrolling cycle ending alignment 1342. A portion of the text 1320 is displayed in the viewport 1310 along with a portion of the advertisement 1322. A user 1390 uses a multi-dimensional gesture comprising a leftward movement followed by an upward movement to decrease scrolling speed or stop scrolling movement completely. The bottom edge of the viewport is aligned at a vertical alignment 1352.

### Example 29

### Exemplary Method of Applying a Combination of the Technologies

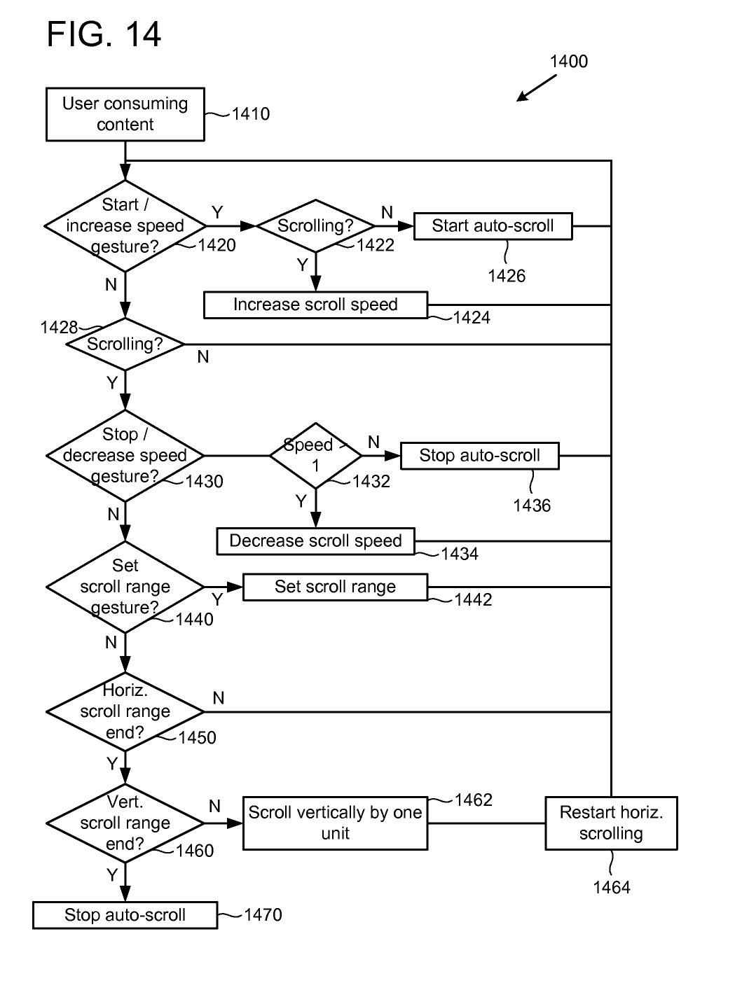

FIG. 14 is a flowchart of an exemplary method 1400 of implementing the multi-dimensional auto-scrolling technologies described herein and can be implemented, for example, in a system such as that shown in FIG. 4.

At 1410, a user is consuming content (e.g., by viewing visual information in a web page, a document, etc.) on a computing device having a touchscreen. The device is capable of receiving and interpreting gestures for controlling multi-dimensional auto-scrolling features. At 1420, the system determines whether a start gesture/speed-increasing gesture has been received. In practice, a start gesture and a speed-increasing gesture can be shaped in the same way (e.g., a right-and-down multi-dimensional gesture for left-to-right reading), and the determination of whether the gesture is a start gesture or a speed-increasing gesture can be based on context (e.g., based on whether multi-dimensional auto-scrolling is already active). If a start gesture/speed-increasing gesture is received, at 1422 the system determines whether multi-dimensional auto-scrolling is already active. If multi-dimensional auto-scrolling is active, the system increases scrolling speed at 1424 and awaits further input or events. (In practice, a scrolling speed increase can be omitted, for example, where an upper limit on scrolling speed has already been reached.) If multi-dimensional auto-scrolling is not active, the system starts multi-dimensional auto-scrolling at 1426 and awaits further input or events.

If auto-scrolling is not already active, gestures other than start gestures can be ignored. Therefore, at 1428 if auto-scrolling is not active, the system can ignore other gestures and await a start gesture. If auto-scrolling is active, at 1430 the system determines whether a stop gesture/speed-decreasing gesture has been received. In practice, a stop gesture and a speed-decreasing gesture can be shaped in the same way (e.g., a left-and-up multi-dimensional gesture for left-to-right reading), and the determination of whether the gesture is a stop gesture or a speed-decreasing gesture can be based on context (e.g., based on whether multi-dimensional auto-scrolling is above a minimum scrolling speed). If a stop gesture/speed-decreasing gesture is received, at 1432 the system determines whether multi-dimensional auto-scrolling is above a minimum speed (represented by the number “1” in the flow chart). If multi-dimensional auto-scrolling is above a minimum speed, the system decreases scrolling speed at 1434 and awaits further input or events. If multi-dimensional auto-scrolling is not above a minimum speed, the system stops multi-dimensional auto-scrolling at 1436 and awaits further input or events.

At 1440, the system determines whether a scroll-range-setting gesture has been received. In practice, the determination of whether the gesture is a scroll-range-setting gesture can be based on context (e.g., based on whether a flick gesture is in the opposite direction of a scrolling direction). If a scroll-range-setting gesture is received, at 1442 the system sets a new scroll range (e.g., by updating a scroll cycle ending alignment, or discarding a previous update to restore a default alignment) and awaits further input or events.

At 1450, the system determines whether the end of a horizontal scroll range has been reached (e.g., at a horizontal scrolling cycle ending alignment). If the horizontal scroll range has not been reached, horizontal scrolling continues and the system awaits further input or events. If the end of the horizontal scroll range has been reached, at 1460 the system determines whether the end of the vertical scrolling range has also been reached (e.g., at an end boundary). If the vertical scroll range has not been reached, the system shifts the content vertically by one unit (e.g., by a displacement of a line of text) at 1462, horizontal scrolling continues (e.g., from a horizontal scrolling cycle starting alignment at a shifted vertical alignment) at 1464, and the system awaits further input or events. If the end of the vertical scroll range has been reached, at 1470 the system stops the auto-scrolling.

### Example 30

### Exemplary Auto-Scroll Interrupt/Pause/Resume

In any of the examples herein, multi-dimensional auto-scrolling can be paused, or restarted after a pause, in response to user input or other events. For example, during multi-dimensional auto-scrolling, a user can pause the auto-scrolling movement by making a gesture on a touchscreen. Pause gestures can include a tap gesture (e.g., a tap gesture on a part of the touchscreen that corresponds to the scrolling content). To avoid unintended results, functionality that might otherwise be activated by a tap gesture, such as a hyperlink in scrolling content, can be deactivated during scrolling. The same gesture (e.g., a tap gesture) also can be used to restart auto-scrolling after it has been paused (e.g., at the same position and scrolling speed at which it was paused). To provide further feedback to the user, a button (e.g., a transparent overlay button with a label such as “Resume Reading”) can be displayed on the content being read or in some other part of the display area to indicate that auto-scrolling can be resumed. When in a paused state, a user can perform other tasks on a device in addition to restarting the auto-scrolling. The technologies described herein can accept any kind of user input, including gestures of all kinds, to pause or resume auto-scrolling.

Auto-scrolling also can be paused without user input. For example, if an event occurs such as an incoming phone call, an incoming text message, a low battery warning, etc., scrolling can be paused and related settings and state information can be preserved so that auto-scrolling can be resumed after the event has been completed, the event notification has been dismissed, etc. It also possible to restart auto-scrolling without user input. For example, auto-scrolling can resume after being paused in response to message notification after a certain amount of time has passed (e.g., a few seconds).

### Example 31

### Exemplary Content Filtering

In any of the examples herein, multi-dimensional auto-scrolling can use content filtering to adjust auto-scrolling based on the content being scrolled. For example, a default setting can be used that causes all content (e.g., text content and non-text content such as images, etc.) to be subject to auto-scrolling, while permitting adjustments to content filtering settings (e.g., via controls presented to a user in a user interface), such as adjustments that cause a multi-dimensional auto-scrolling tool to auto-scroll only text and prevent other content such as images from scrolling partially or completely into view. Such adjustments can be useful where a user wishes to avoid viewing advertisements or other sandboxed content. Content also can be resized to allow emphasis on particular types of content. For example, graphics, images, animations, advertisements, interactive controls, etc. can be made smaller to allow more focus on neighboring text. Different applications can have content detection and content filtering settings that are specific to the application.

The technologies described herein can accept any kind of user input, including gestures of all kinds, to activate, deactivate, or adjust content filtering, or content filtering can proceed without user input (e.g., in response to default or automatic settings).

### Example 32

### Exemplary Behavior with Less than Two Scrolling Dimensions

In any of the examples herein, gestures, functionality, etc., that are described as being associated with multi-dimensional auto-scrolling also can be used in situations where scrolling is not available in more than one dimension. For example, a multi-dimensional gesture can still be used to begin an auto-scrolling movement where scrolling is available in only one dimension (e.g., a vertical dimension). Scrolling may be available in only one dimension for many reasons. For example, visual information may extend beyond a viewport in only one dimension, content filtering may prevent scrolling in a particular dimension, or an updated scrolling cycle ending alignment may prevent scrolling in a particular dimension. In such a case, a multi-dimensional auto-scrolling tool can omit scrolling in one dimension (e.g., a horizontal dimension) and instead scroll only in the available dimension (e.g., a vertical dimension). In any of the examples herein, scrolling can alternate between different numbers of dimensions depending on content size, user settings, etc. Auto-scrolling can be omitted in cases where there are no scrolling dimensions available.

### Example 33

### Exemplary Multipage Scrolling

In any of the examples multi-dimensional auto-scrolling also can be used to perform auto-scrolling across several pages. Although single pages may typically have an end boundary at the end of the page to prevent scrolling beyond the end of the page, in a multipage scenario (e.g., when a user is reading an electronic book (“e-book”) on an e-book reader device or with an e-book reader application on a more general purpose device), multi-dimensional auto-scrolling can continue across multiple pages. For example, when the end of a current page is reached, a multi-dimensional auto-scrolling tool can continue auto-scrolling (e.g., by beginning a new horizontal scrolling cycle at the beginning of the next page) until, for example, the last page has been scrolled or some other event occurs, such as a stop gesture.

### Example 34

### Exemplary User Interface for Parameter Control

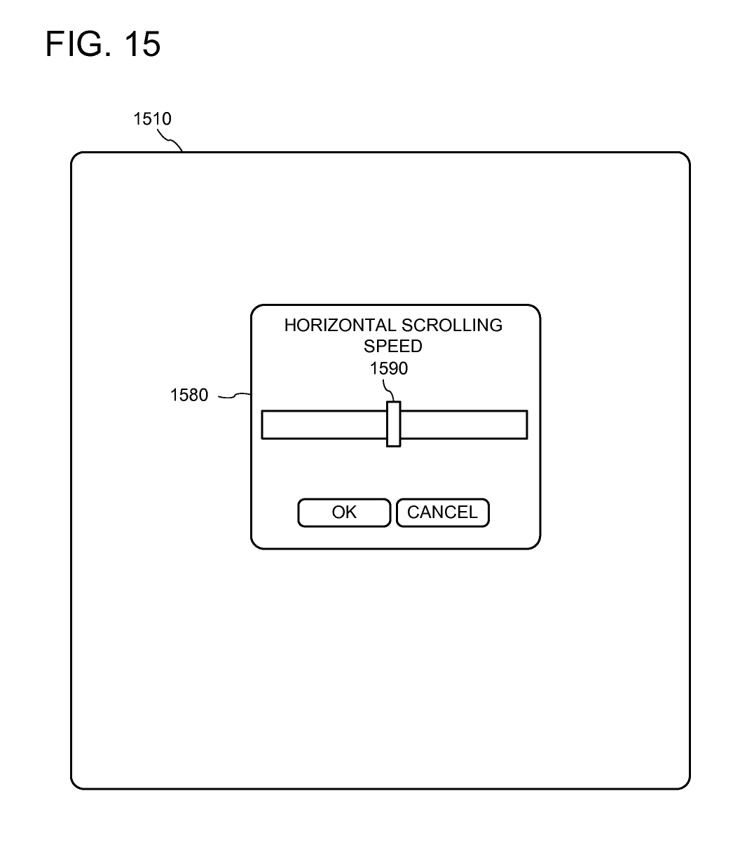

FIG. 15 is a conceptual diagram of an exemplary user interface 1510 accepting input of additional information related to multi-dimensional auto-scrolling technologies described herein. In the example, a user has selected a moderate horizontal scrolling speed by adjusting a slider control 1590. The user interface 1510 responds by accepting additional information (e.g., via the box 1580) about the desired horizontal scrolling speed from the user.

Additional information that can be provided by a user via user interface 1510 can include content-based scrolling options (e.g., a check-box to indicate that scrolling cycles should skip images), gesture sensitivity controls, or the like.

### Example 35

### Exemplary Display Area

In any of the examples herein, a display area can be any area of a device that is configured to display visual information. Display areas can include, for example, display areas of touchscreens, which combine input and output functionality, or display areas of displays that are used for output only, such as desktop computer or laptop computer displays without touch input functionality. Described techniques and tools can be used with display areas of any size, shape or configuration.

### Example 36

### Exemplary Touchscreen

In any of the examples herein, a touchscreen can be used for user input. Touchscreens can accept input in different ways. For example, capacitive touchscreens can detect touch input when an object (e.g., a fingertip) distorts or interrupts an electrical current running across the surface. As another example, resistive touchscreens can detect touch input when a pressure from an object (e.g., a fingertip or stylus) causes a compression of the physical surface. As another example, touchscreens can use optical sensors to detect touch input when beams from the optical sensors are interrupted. Physical contact with the surface of the screen is not necessary for input to be detected by some touchscreens. The act of contacting (or, where physical contact is not necessary, coming into close enough proximity to the touchscreen) a touchscreen in some way to generate user input can be referred to as a gesture. Described techniques and tools can be used with touchscreens of any size, shape or configuration.

### Example 37

### Exemplary Viewport

In any of the examples herein, a viewport is an element in which content is displayed in a display area. In some cases, such as when a web browser or other content viewer is in a full-screen mode, an entire display area can be occupied by a viewport. In other cases, a viewport occupies only a portion of a display area and shares the display area with other elements, such as graphical elements (e.g., borders, backgrounds) and/or functional elements (e.g., scroll bars, control buttons, etc.). Display areas can include more than one viewport. For example, multiple viewports can be used in the same display area to view multiple collections of content (e.g., different web pages, different documents, etc.). Viewports can occupy static positions in a display area, or viewports can be moveable (e.g., moveable by a user). The size, shape and orientation of viewports can be static or changeable (e.g., adjustable by a user). For example, viewports can be in a landscape or portrait orientation, and the orientation can be changed in response to events such as rotation of a device. Described techniques and tools can be used with viewports of any size, shape or configuration.

### Example 38

### Exemplary User Input

In any of the examples herein, a user can interact with a device to control display of visual information via different kinds of user input. For example, a user can initiate, pause, resume, adjust or end an auto-scroll movement by interacting with a touchscreen. Alternatively, or in combination with touchscreen input, a user can control display of visual information in some other way, such as by pressing buttons (e.g., directional buttons) on a keypad or keyboard, moving a trackball, pointing and clicking with a mouse, making a voice command, etc. The technologies described herein can be implemented to work with any such user input.

### Example 39

### Exemplary Computing Environment

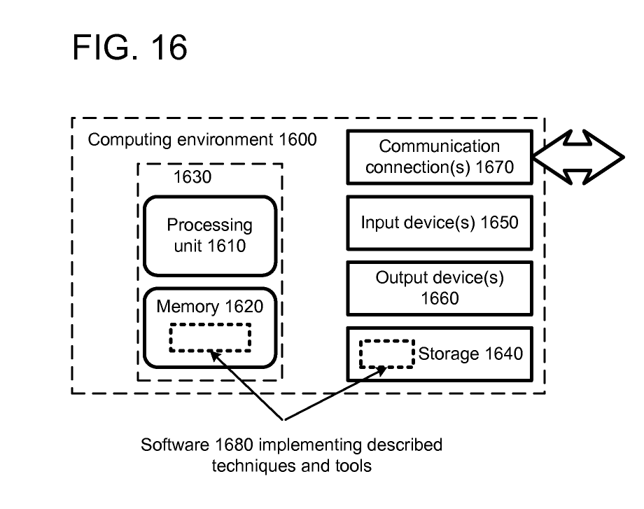

FIG. 16 illustrates a generalized example of a suitable computing environment 1600 in which the described technologies can be implemented. The computing environment 1600 is not intended to suggest any limitation as to scope of use or functionality, as the technologies may be implemented in diverse general-purpose or special-purpose computing environments.

With reference to FIG. 16, the computing environment 1600 includes at least one processing unit 1610 coupled to memory 1620. In FIG. 16, this basic configuration 1630 is included within a dashed line. The processing unit 1610 executes computer-executable instructions and may be a real or a virtual processor. In a multi-processing system, multiple processing units execute computer-executable instructions to increase processing power. The memory 1620 may be volatile memory (e.g., registers, cache, RAM), non-volatile memory (e.g., ROM, EEPROM, flash memory, etc.), or some combination of the two. The memory 1620 can store software 1680 implementing any of the technologies described herein.

A computing environment may have additional features. For example, the computing environment 1600 includes storage 1640, one or more input devices 1650, one or more output devices 1660, and one or more communication connections 1670. An interconnection mechanism (not shown) such as a bus, controller, or network interconnects the components of the computing environment 1600. Typically, operating system software (not shown) provides an operating environment for other software executing in the computing environment 1600, and coordinates activities of the components of the computing environment 1600.

The storage 1640 may be removable or non-removable, and includes magnetic disks, magnetic tapes or cassettes, CD-ROMs, CD-RWs, DVDs, or any other computer-readable media which can be used to store information and which can be accessed within the computing environment 1600. The storage 1640 can store software 1680 containing instructions for any of the technologies described herein.

The input device(s) 1650 may be a touch input device such as a keyboard, mouse, pen, or trackball, a voice input device, a scanning device, or another device that provides input to the computing environment 1600. For audio, the input device(s) 1650 may be a sound card or similar device that accepts audio input in analog or digital form, or a CD-ROM reader that provides audio samples to the computing environment. The output device(s) 1660 may be a display, printer, speaker, CD-writer, or another device that provides output from the computing environment 1600. Some input/output devices, such as a touchscreen, may include both input and output functionality.

The communication connection(s) 1670 enable communication over a communication mechanism to another computing entity. The communication mechanism conveys information such as computer-executable instructions, audio/video or other information, or other data. By way of example, and not limitation, communication mechanisms include wired or wireless techniques implemented with an electrical, optical, RF, infrared, acoustic, or other carrier.

The techniques herein can be described in the general context of computer-executable instructions, such as those included in program modules, being executed in a computing environment on a target real or virtual processor. Generally, program modules include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing environment.

### Example 40

### Exemplary Implementation Environment

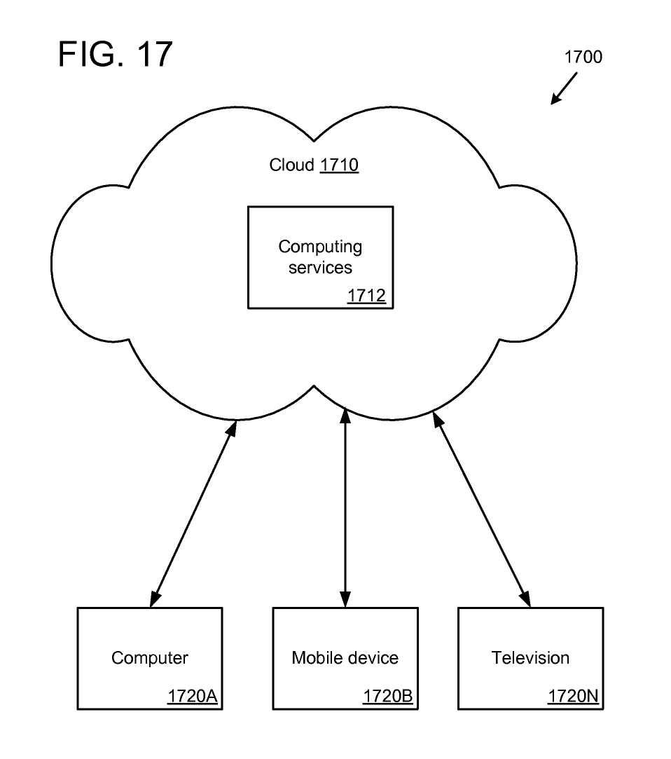

FIG. 17 illustrates a generalized example of a suitable implementation environment 1700 in which described embodiments, techniques, and technologies may be implemented.

In example environment 1700, various types of services (e.g., computing services 1712) are provided by a cloud 1710. For example, the cloud 1710 can comprise a collection of computing devices, which may be located centrally or distributed, that provide cloud-based services to various types of users and devices connected via a network such as the Internet. The cloud computing environment 1700 can be used in different ways to accomplish computing tasks. For example, with reference to described techniques and tools, some tasks, such as processing user input and presenting a user interface, can be performed on a local computing device, while other tasks, such as storage of data to be used in subsequent processing, can be performed elsewhere in the cloud.

In example environment 1700, the cloud 1710 provides services for connected devices with a variety of screen capabilities 1720A-N. Connected device 1720A represents a device with a mid-sized screen. For example, connected device 1720A could be a personal computer such as desktop computer, laptop, notebook, netbook, or the like. Connected device 1720B represents a device with a small-sized screen. For example, connected device 1720B could be a mobile phone, smart phone, personal digital assistant, tablet computer, and the like. Connected device 1720N represents a device with a large screen. For example, connected device 1720N could be a television (e.g., a smart television) or another device connected to a television or projector screen (e.g., a set-top box or gaming console).

A variety of services can be provided by the cloud 1710 through one or more service providers (not shown). For example, the cloud 1710 can provide services related to mobile computing to one or more of the various connected devices 1720A-N. Cloud services can be customized to the screen size, display capability, or other functionality of the particular connected device (e.g., connected devices 1720A-N). For example, cloud services can be customized for mobile devices by taking into account the screen size, input devices, and communication bandwidth limitations typically associated with mobile devices.

### Example 41

### Exemplary Mobile Device

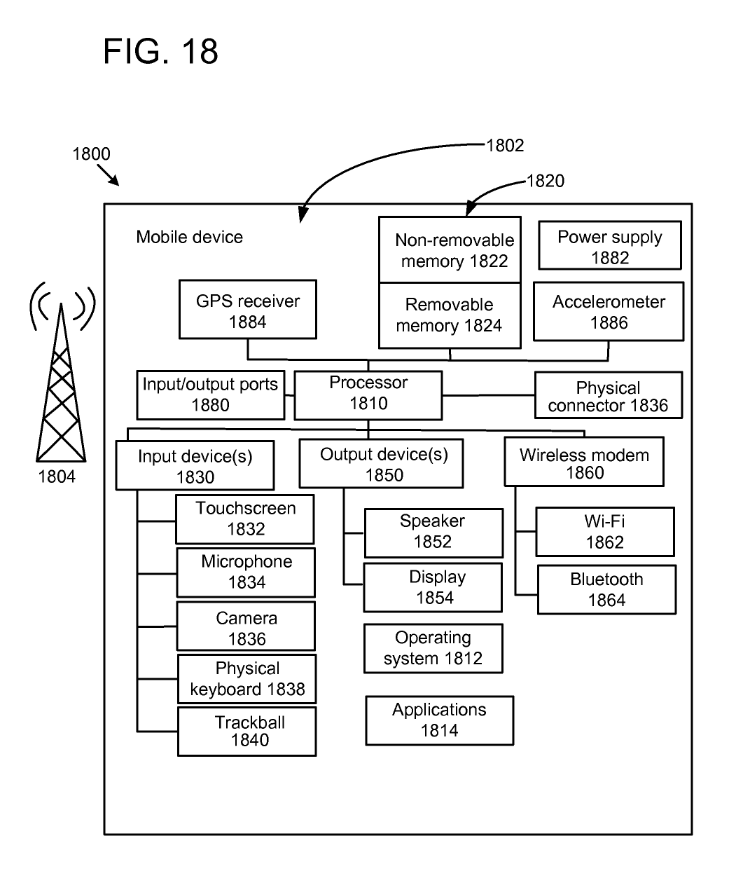

FIG. 18 is a system diagram depicting an exemplary mobile device 1800 including a variety of optional hardware and software components, shown generally at 1802. Any components 1802 in the mobile device can communicate with any other component, although not all connections are shown, for ease of illustration. The mobile device can be any of a variety of computing devices (e.g., cell phone, smartphone, handheld computer, personal digital assistant (PDA), etc.) and can allow wireless two-way communications with one or more mobile communications networks 1804, such as a cellular or satellite network.

The illustrated mobile device can include a controller or processor 1810 (e.g., signal processor, microprocessor, ASIC, or other control and processing logic circuitry) for performing such tasks as signal coding, data processing, input/output processing, power control, and/or other functions. An operating system 1812 can control the allocation and usage of the components 1802 and support for one or more application programs 1814. The application programs can include common mobile computing applications (e.g., include email applications, calendars, contact managers, web browsers, messaging applications), or any other computing application.

The illustrated mobile device can include memory 1820. Memory 1820 can include non-removable memory 1822 and/or removable memory 1824. The non-removable memory 1822 can include RAM, ROM, flash memory, a disk drive, or other well-known memory storage technologies. The removable memory 1824 can include flash memory or a Subscriber Identity Module (SIM) card, which is well known in GSM communication systems, or other well-known memory storage technologies, such as smart cards. The memory 1820 can be used for storing data and/or code for running the operating system 1812 and the applications 1814. Example data can include web pages, text, images, sound files, video data, or other data sets to be sent to and/or received from one or more network servers or other mobile devices via one or more wired or wireless networks. The memory 1820 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device can support one or mare input devices 1830, such as a touchscreen 1832, microphone 1834, camera 1836, physical keyboard 1838 and/or trackball 1840 and one or more output devices 1850, such as a speaker 1852 and a display 1854. Other possible output devices (not shown) can include a piezoelectric or other haptic output device. Some devices can serve more than one input/output function. For example, touchscreen 1832 and display 1854 can be combined in a single input/output device.

Touchscreen 1832 can accept input in different ways. For example, capacitive touchscreens can detect touch input when an object (e.g., a fingertip) distorts or interrupts an electrical current running across the surface. As another example, resistive touchscreens can detect touch input when a pressure from an object (e.g., a fingertip or stylus) causes a compression of the physical surface. As another example, touchscreens can use optical sensors to detect touch input when beams from the optical sensors are interrupted. Physical contact with the surface of the screen is not necessary for input to be detected by some touchscreens.

A wireless modem 1860 can be coupled to an antenna (not shown) and can support two-way communications between the processor 1810 and external devices, as is well understood in the art. The modem 1860 is shown generically and can include a cellular modem for communicating with the mobile communication network 1804 and/or other radio-based modems (e.g., Bluetooth or Wi-Fi). The wireless modem 1860 is typically configured for communication with one or more cellular networks, such as a GSM network for data and voice communications within a single cellular network, between cellular networks, or between the mobile device and a public switched telephone network (PSSTN).

The mobile device can further include at least one input/output port 1880, a power supply 1882, a satellite navigation system receiver 1884, such as a global positioning system (GPS) receiver, an accelerometer 1886, a transceiver 1888 (for wirelessly transmitting analog or digital signals) and/or a physical connector 1890, which can be a USB port, IEEE 1394 (firewall) port, and/or RS-232 port. The illustrated components 1802 are not required or all-inclusive, as components can be deleted and other components can be added.

### Storing in Computer-Readable Media

Any of the storing actions described herein can be implemented by storing in one or more computer-readable media (e.g., computer-readable storage media or other tangible media).

Any of the things described as stored can be stored in one or more computer-readable media (e.g., computer-readable storage media or other tangible media).

### Methods in Computer-Readable Media

Any of the methods described herein can be implemented by computer-executable instructions in (e.g., encoded on) one or more computer-readable media (e.g., computer-readable storage media or other tangible media). Such instructions can cause a computer to perform the method. The technologies described herein can be implemented in a variety of programming languages.

### Methods in Computer-Readable Storage Devices

Any of the methods described herein can be implemented by computer-executable instructions stored in one or more computer-readable storage devices (e.g., memory, CD-ROM, CD-RW, DVD, or the like). Such instructions can cause a computer to perform the method.

### Alternatives

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. I therefore claim as my invention all that comes within the scope and spirit of these claims.

I claim:

1. A computer-implemented method comprising:
receiving a first user input;
responsive to the first user input, scrolling visual information in a user interface in a first dimension from a first-dimension scrolling cycle starting alignment to a first-dimension scrolling cycle ending alignment;
responsive to the first user input, aligning the visual information in a second dimension orthogonal to the first dimension at a shifted, second-dimension alignment;
responsive to the first user input, aligning the visual information at the first-dimension scrolling cycle starting alignment; and
responsive to the first user input, scrolling the visual information in the first dimension from the first-dimension scrolling cycle starting alignment to the first-dimension scrolling cycle ending alignment while maintaining the shifted alignment in the second dimension.

2. One or more computer-readable storage devices having encoded thereon computer-executable instructions operable to cause a computer to perform the method of claim 1.

3. The method of claim 1 wherein the first user input comprises a gesture on a touchscreen.

4. The method of claim 3 wherein the gesture is a multi-dimensional gesture comprising a horizontal movement and a vertical movement.

5. The method of claim 1 wherein the first-dimension scrolling cycle ending alignment is a default alignment.

6. The method of claim 1 wherein the first-dimension scrolling cycle ending alignment is determined responsive to a gesture on a touchscreen after the first user input.

7. The method of claim 6 wherein the gesture comprises a flick gesture in a direction opposite of the direction of the scrolling in the first dimension.

8. The method of claim 1 wherein the first-dimension scrolling cycle starting alignment is determined responsive to selection of a scrolling cycle starting alignment prior to the scrolling in the first dimension.

9. The method of claim 1 wherein the first user input comprises a first gesture on a touchscreen comprising a first movement, the method further comprising stopping scrolling of the visual information in response to a second gesture on the touchscreen, wherein the second gesture comprises a second movement in an opposite direction of the first movement.

10. The method of claim 1 further comprising pausing the multi-dimensional auto-scroll movement in response to a tap gesture on a touchscreen.

11. The method of claim 10 further comprising resuming the multi-dimensional auto-scroll movement in response to a second tap gesture on the touchscreen.

12. The method of claim 1 wherein the scrolling in the first dimension has a variable scrolling speed that is controllable by a user.

13. The method of claim 1 wherein the shifted, second-dimension alignment is shifted at a vertical displacement equivalent to a line of text in the visual information.

14. A computing device comprising:
one or more processors;
a touchscreen having a display area; and
one or more computer readable storage media having stored therein computer-executable instructions for performing a method comprising:
receiving first user input consisting of a first multi-dimensional gesture on the touchscreen, the multi-dimensional gesture comprising a horizontal component and a vertical component;
in response to the first multi-dimensional gesture, scrolling visual information in a user interface in a horizontal direction at a horizontal scrolling speed to a horizontal scrolling cycle ending alignment, wherein the horizontal direction is based on the horizontal component of the first multi-dimensional gesture;
in response to the first multi-dimensional gesture, aligning the visual information at a horizontal scrolling cycle starting alignment and at a shifted vertical alignment; and
in response to the first multi-dimensional gesture, scrolling the visual information in the horizontal direction from the horizontal scrolling cycle starting alignment to the horizontal scrolling cycle ending alignment at the horizontal scrolling speed while maintaining the shifted vertical alignment.

15. The system of claim 14 wherein the method further comprises:
receiving second user input consisting of a second multi-dimensional gesture on the touchscreen, the second multi-dimensional gesture comprising a second horizontal component having a direction similar to the first horizontal component and a second vertical component having a direction similar to the first vertical component; and
in response to the received second multi-dimensional gesture, increasing the horizontal scrolling speed.

16. The system of claim 14 wherein the method further comprises:
receiving second user input consisting of a second gesture on the touchscreen; and
in response to the received second gesture, decreasing the horizontal scrolling speed.

17. The system of claim 14 wherein the horizontal component comprises a left-to-right movement, and wherein the horizontal direction of the scrolling is left-to-right.

18. The system of claim 14 wherein the horizontal component comprises a right-to-left movement, and wherein the horizontal direction of the scrolling is right-to-left.

19. The system of claim 14 wherein the vertical component comprises a downward movement, and wherein the shifted vertical alignment is a vertical alignment in which at least part of the visual information is shifted up in the display area.

20. One or more computer-readable storage media having encoded thereon computer-executable instructions causing a computer to perform a method comprising:
receiving first user input consisting of a first multi-dimensional gesture on a touchscreen, the multi-dimensional gesture comprising a horizontal movement followed by a downward movement;
in response to the received multi-dimensional gesture, scrolling visual text information at a scrolling speed in a user interface in a horizontal direction from a horizontal scrolling cycle starting alignment to a horizontal scrolling cycle ending alignment, wherein the horizontal direction corresponds to the horizontal movement, and wherein the scrolling speed is controllable by a user via the touchscreen;
upon reaching the horizontal scrolling cycle ending alignment and without further user input, aligning the visual text information at the horizontal scrolling cycle starting alignment and at a shifted vertical alignment, wherein the shifted vertical alignment is a vertical alignment in which at least part of the visual text information is shifted up in a display area by a vertical displacement equivalent to a line of text in the visual text information;
without further user input, scrolling the visual text information in the horizontal direction from the horizontal scrolling cycle starting alignment to the horizontal scrolling cycle ending alignment while maintaining the shifted vertical alignment; and
repeating the aligning and the scrolling from the horizontal scrolling cycle starting alignment to the horizontal scrolling cycle ending alignment until an end boundary is reached or the scrolling is stopped in response to second user input.
